(19) United States
(12) Patent Application Publication
(10) Pub. No.: US 2026/0336081 A1
(43) Pub. Date: Oct. 29, 2026

(54) POWERED FASTENER DRIVER

(71) Applicant: MILWAUKEE ELECTRIC TOOL CORPORATION, Brookfield, WI (US)

(72) Inventors: Connor D. Sreenan, Wauwatosa, WI (US); Bradley S. Houskamp, Wauwatosa, WI (US); Jackson E. Troll, Milwaukee, WI (US); Ivan N. Zozulya, Waukesha, WI (US); Brooke E. Ehle, Pewaukee, WI (US); Kyle A. Greunke, Auborndale, WI (US)

(21) Appl. No.: 19/655,852

(22) Filed: Apr. 23, 2026

Related U.S. Application Data
(60) Provisional application No. 63/794,457, filed on Apr. 25, 2025.
(60) Provisional application No. 63/898,754, filed on Oct. 14, 2025.

(51) Int. Cl. B25C 1/06; F21V 33/00

(52) U.S. Cl. CPC B25C 1/06; F21V 33/0084

(57) ABSTRACT

A powered fastener driver including: a housing; a nosepiece coupled to the housing and at least partially defining a fastener driving channel; a light assembly positioned within the housing forward of the nosepiece, the light assembly including a light emitting diode; an electronic control unit positioned within the housing and being in electrical communication with the light assembly to power the light emitting diode of the light assembly.

### CROSS-REFERENCE TO RELATED APPLICATIONS

The present application claims priority to U.S. Provisional Patent Application No. 63/898,754, filed Oct. 14, 2025, and to U.S. Provisional Patent Application No. 63/794,457, filed Apr. 25, 2025, the entire contents of each of which is incorporated herein by reference.

### FIELD OF THE INVENTION

The present invention relates to powered fastener drivers.

### BACKGROUND OF THE INVENTION

There are various fastener drivers known in the art for driving fasteners (e.g., nails, tacks, staples, etc.) into a workpiece. These fastener drivers operate utilizing various means known in the art (e.g., compressed air generated by an air compressor, electrical energy, a flywheel mechanism, etc.), but often these designs are met with power, size, and cost constraints.

### SUMMARY OF THE INVENTION

In some aspects, the techniques described herein relate to a powered fastener driver including: a housing; a nosepiece coupled to the housing and at least partially defining a fastener driving channel; a light assembly positioned within the housing forward of the nosepiece, the light assembly including a light emitting diode; an electronic control unit positioned within the housing and being in electrical communication with the light assembly to power the light emitting diode of the light assembly.

In some aspects, the techniques described herein relate to a powered fastener driver including: a housing; a nosepiece coupled to the housing and at least partially defining a fastener driving channel; a light assembly positioned within the housing at a bottom end thereof and forward of the nosepiece, the light assembly including a light emitting diode; and an electronic control unit positioned within the housing and being in electrical communication with the light assembly to power the light emitting diode of the light assembly.

In some aspects, the techniques described herein relate to a powered fastener driver including: a housing; a nosepiece coupled to the housing and at least partially defining a fastener driving channel; a light assembly positioned within the housing forward of the nosepiece, the light assembly including a light emitting diode and a wire in electrical communication with the light emitting diode; an electronic control unit positioned within the housing and being in electrical communication with the light assembly via the wire to power the light emitting diode of the light assembly; and a guide coupled to a side of the nosepiece, the guide configured to support the wire between the light emitting diode and the electronic control unit.

In some aspects, the techniques described herein relate to a powered fastener driver including: a housing; a nosepiece coupled to the housing and at least partially defining a fastener driving channel; a workpiece contact assembly movably supported by the nosepiece and including a first end, a second end opposite the first end, and a projection extending from the first end, the workpiece contact assembly movable from an extended position to a retracted position in response to contact by the second end with a workpiece, the workpiece contact assembly biased into the extended position; and a depth adjustment mechanism movably supported by the nosepiece, the depth adjustment mechanism including a shuttle having a channel with a plurality of steps, the projection of the workpiece contact assembly received within the channel and configured to selectively engage each of the plurality of steps to set a length between the second end of the workpiece contact assembly and a distal end of the nosepiece; and an actuator configured to move the shuttle transverse to the fastener driving channel to move the projection within the channel and thereby adjust the length between the distal end of the workpiece contact assembly and the distal end of the nosepiece.

In some aspects, the techniques described herein relate to a collation for use in a magazine assembly of a powered fastener driver, the collation including: a front end; a rear end opposite the front end; a top side; a bottom side opposite the top side; and a plurality of receptacles extending consecutively from the rear end to the front end, each of the plurality of receptacles including an aperture extending along an axis and configured to receive a fastener; an upper crush zone positioned adjacent the top side and defining a first plane that is parallel to the axis; and a lower crush zone positioned adjacent to the bottom side and defining a second plane that is transverse to the axis and to the first plane.

In some aspects, the techniques described herein relate to a powered fastener driver including: a housing; a nosepiece coupled to the housing and at least partially defining a fastener driving channel; and a workpiece contact assembly movably supported by the nosepiece and movable from an extended position to a retracted position in response to contact with a workpiece, the workpiece contact assembly biased into the extended position, the workpiece contact assembly including an upper workpiece contact member, a lower workpiece contact member removably coupled to the upper workpiece contact member, the lower workpiece contact member including a first end, a second end opposite the first end, a barrel extending from the second end towards the first end, the barrel configured to at least partially define the fastener driving channel, and a latch including a projection, the latch pivotably coupled to one of the upper workpiece contact member and the lower workpiece contact member, the latch being pivotable between a latched position and a released position, wherein in latched positioned the projection is positioned within a groove in the other of the upper workpiece contact member and the lower workpiece contact member to couple the lower workpiece contact member to the upper workpiece contact member, and wherein in the released position the projection is spaced apart from the groove to permit the lower workpiece contact member to be removed from the upper workpiece contact member, a spring configured to bias the latch into the latched position, and an actuator configured to move the latch from the latched position to the released position against a bias of the spring, the actuator accessible from outside the housing.

In some aspects, the techniques described herein relate to a powered fastener driver including: a housing; a nosepiece coupled to the housing and at least partially defining a fastener driving channel; an inductive sensor coupled to the nosepiece; a magazine assembly coupled to the nosepiece and configured to receive a plurality of fasteners; a pusher assembly slidably coupled to the magazine assembly, the pusher assembly configured to bias the plurality of fasteners within the magazine assembly toward the fastener driving channel, the pusher assembly including a metal member; and an electronic control unit positioned within the housing and being configured to: receive a control signal from the inductive sensor in response to a detected gap between the inductive sensor and the metal member being less than a predetermined distance, indicating that a predetermined number of fasteners are in the magazine assembly, and disable the powered fastener driver in response to receiving the control signal.

In some aspects, the techniques described herein relate to a powered fastener driver including: a housing; a nosepiece coupled to the housing and at least partially defining a fastener driving channel; a magazine assembly coupled to the nosepiece and configured to receive fasteners and guide the fasteners consecutively to the fastener driving channel, the magazine assembly including a front end coupled to the nosepiece, a rear end opposite the front end, a top side, a bottom side opposite the front end, and a projection extending from the top side and positioned between the front end and the rear end, the projection configured to extend into the housing, the projection defining a groove; and an over-center latch coupled to the housing and configured to removably couple the magazine assembly to the housing, the over-center latch including a first link pivotally coupled to the housing, a second link pivotally coupled to the first link, the second link pivotable between an engaged position in which at least a portion of the second link is positioned within the groove to couple the magazine assembly to the housing and a disengaged position in which the second link is removed from the groove to allow the magazine assembly to be removed from the housing, and an actuator coupled to the first link, wherein the actuator is configured to pivot the first link in a first direction causing the second link to pivot in a second direction from the engaged position to the disengaged position, and wherein the actuator is configured to pivot the first link in the second direction causing the second link to pivot in the first direction from the engaged position to the disengaged position.

In some aspects, the techniques described herein relate to a powered fastener driver including: a housing; a nosepiece coupled to the housing and at least partially defining a fastener driving channel; a magazine assembly coupled to the nosepiece and configured to receive fasteners and guide the fasteners consecutively to the fastener driving channel, the magazine assembly having a body with a front end coupled to the nosepiece, a rear end opposite the front end, a top side, a bottom side opposite the top side, a first side, and a second side opposite the first side; and a kickstand including a first end and a second end opposite the first side, the first end pivotably coupled to the first side of the magazine assembly and the second end including a first support foot and a second support foot configured to support the powered fastener driver in an upright position.

In some aspects, the techniques described herein relate to a powered fastener driver including: a housing; an inner frame positioned within the housing; a storage chamber cylinder positioned within the housing and integrally formed with the inner frame; an inner cylinder positioned within the storage chamber cylinder; a piston movable within the inner cylinder from a top-dead-center (TDC) position to a driven or bottom-dead-center (BDC) position; a driver blade attached to the piston for movement therewith along a driving axis from the TDC position toward the BDC position for driving a fastener into a workpiece; a lifter supported by the inner frame and operable to move the piston and the driver blade from the BDC position toward the TDC position; a nosepiece coupled to the inner frame and at least partially defining a fastener driving channel; and a latch assembly supported by the nosepiece, the latch assembly including a latch supported by the nosepiece and engageable with the driver blade for maintaining the driver blade in a ready position between the BDC position and the TDC position, and a latch engagement member integrated with the lifter and configured to selectively move the latch from a latched position to a released position to permit driving of the piston and the driver blade toward the BDC position.

In some aspects, the techniques described herein relate to a powered fastener driver including: a housing; a nosepiece coupled to the housing and at least partially defining a fastener driving channel and a guide channel separate from the fastener driving channel; an inner cylinder positioned within the housing; a piston movable within the inner cylinder from a top-dead-center (TDC) position to a driven or bottom-dead-center (BDC) position; a driver blade attached to the piston for movement therewith along a driving axis from the TDC position toward the BDC position for driving a fastener into a workpiece, the driver blade at least partially supported within the guide channel and movably supported by the nosepiece to drive fasteners through the fastener driving channel; and a lifter positioned within the housing and operable to move the piston and the driver blade from the BDC position toward the TDC position.

In some aspects, the techniques described herein relate to a magazine assembly configured to be coupled to a nosepiece of a powered fastener driver and to consecutively advance a plurality of fasteners therein to a fastener driving channel of the nosepiece, the magazine assembly including: a magazine body including a front end, a rear end, a fastener channel extending between the front end and the rear end and configured to receive the plurality of fasteners, a recess at or adjacent to the rear end, and a projection extending therefrom and positioned between the front end and the rear end; a pusher assembly slidably coupled to the magazine assembly, the pusher assembly configured to bias the plurality of fasteners within the magazine body toward the fastener driving channel, the pusher assembly including a pusher body slidably coupled to the magazine body, a pusher finger movably coupled to the pusher body, the pusher finger includes a first end configured to engage a fastener of the plurality of fasteners, a second end, and a cam, and an actuator movably coupled to the pusher body, the actuator including a body and a tab extending from the body; wherein the pusher assembly is movable between a first position in which the pusher body is positioned at or adjacent to the rear end to a second position in which the pusher body is positioned at or adjacent to the front end; wherein the pusher finger is movable between an engaged position in which the first end is positioned within the fastener channel and a bypass position in which the first end is outside the fastener channel, the pusher finger biased into the engaged position and configured to engage the projection to move to the bypass position; wherein the actuator is movable between an unlocked position in which the pusher body is movable relative to the magazine body and a locked position in which the pusher body is locked relative to the magazine body; wherein the actuator is biased into the locked position when the pusher assembly is in the first position; and wherein when the pusher assembly is in the first position and the actuator is in the locked position, the cam is engaged with the projection such that the pusher finger is in the bypass position and the plurality of fasteners can be loaded into the fastener channel.

In some aspects, the techniques described herein relate to a powered fastener driver including: a housing; a nosepiece coupled to the housing and at least partially defining a fastener driving channel; an inductive sensor supported by the nosepiece; a spring-biased plunger supported by the nosepiece and including a metal member, the spring-biased plunger movable between a disengaged position in which the metal member is spaced apart from the inductive sensor and an engaged position in which the metal member is at least partially aligned with the inductive sensor; a magazine assembly coupled to the nosepiece and configured to receive a plurality of fasteners; a pusher assembly slidably coupled to the magazine assembly, the pusher assembly configured to bias the plurality of fasteners within the magazine assembly toward the fastener driving channel and configured to move the spring-biased plunger from the disengaged position to the engaged position; and an electronic control unit positioned within the housing and being configured to: receive a control signal from the inductive sensor in response to the inductive sensor sensing the metal member of the spring-biased plunger when the spring-biased plunger is in the engaged position, indicating that a predetermined number of fasteners are in the magazine assembly, and disable the powered fastener driver in response to receiving the control signal.

### BRIEF DESCRIPTION OF DRAWINGS

FIG. 1A is perspective view of a powered fastener driver.

FIG. 1B is perspective view of the powered fastener driver of FIG. 1A.

FIG. 2 is a cross-sectional view of the powered fastener driver of FIG. 1A taken along the line 2-2 of FIG. 1A.

FIG. 2A is a perspective view of a nosepiece and a driver blade of the powered fastener driver of FIG. 1A.

FIG. 2B is another perspective view of the nosepiece and the driver blade of FIG. 2A.

FIG. 2C is illustrates an inner surface of a rear wall of the nosepiece of FIG. 2A.

FIG. 2D is illustrates an inner surface of a front wall of the nosepiece of FIG. 2A.

FIG. 2E is a cross-sectional view of the nosepiece and driver blade of FIG. 2A taken along the line 2E-2E of FIG. 2A.

FIG. 2F is a cross-sectional view of the nosepiece and driver blade of FIG. 2A taken along the line 2F-2F of FIG. 2A.

FIG. 2G is a perspective view of the driver blade of FIG. 2A.

FIG. 2H is another perspective view of the driver blade of FIG. 2A.

FIG. 2I is a detailed perspective view of a portion of the driver blade of FIG. 2G.

FIG. 2J is a detailed side view of a portion of the driver blade of FIG. 2G.

FIG. 2K is a perspective view of another driver blade suitable for use with the powered fastener driver of FIG. 1A.

FIG. 2L is a detailed perspective view of a portion of the driver blade of FIG. 2K.

FIG. 2M is another detailed perspective view of a portion of the driver blade of FIG. 2K.

FIG. 2N is a plan view of a portion of a nosepiece suitable for use with the driver blade of FIG. 2K.

FIG. 2O is a detailed plan view of the portion of the nosepiece and the portion of the driver blade of FIG. 2N.

FIG. 2P is a detailed perspective view of the portion of the nosepiece and the portion of the driver blade of FIG. 2N.

FIG. 2Q is a detailed view of the nosepiece and the driver blade of FIG. 2N.

FIG. 2R is a detailed view of the nosepiece and the driver blade of FIG. 2Q.

FIG. 3A is a perspective view of the powered fastener driver with portions removed for clarity, and illustrating a motor, a transmission, and a lifter assembly of the powered fastener driver of FIG. 1A.

FIG. 3B is a cross-sectional view of the powered fastener driver of FIG. 3A taken along the line 3B-3B of FIG. 3A.

FIG. 3C is perspective view of a latch assembly of the powered fastener driver of FIG. 1A.

FIG. 3D is a front view of the latch assembly of FIG. 3C.

FIG. 4A is a cross-sectional view of the powered fastener driver of FIG. 1A taken along the line 4A-4A of FIG. 1B.

FIG. 4B is a schematic view of the powered fastener driver of FIG. 1A, illustrating a driver blade in a driven or bottom-dead-center position.

FIG. 4C is a schematic view of the powered fastener driver of FIG. 1A, illustrating a driver blade in a top-dead-center position prior to actuation.

FIG. 5A is perspective view of a depth adjustment assembly and a workpiece contact assembly relative to a nosepiece of the powered fastener driver of FIG. 1A.

FIG. 5B is another perspective view of the depth adjustment assembly and the workpiece contact assembly of FIG. 5A.

FIG. 5C is another perspective view of the depth adjustment assembly and the workpiece contact assembly of FIG. 5A with portions removed for clarity.

FIG. 5D is a cross-sectional view of the depth adjustment assembly of FIG. 5A along the line 5D-5D of FIG. 5B.

FIG. 6A is a perspective view of a shuttle frame of the depth adjustment assembly of FIG. 5A.

FIG. 6B is perspective view of a shuttle of the depth adjustment assembly of FIG. 5A.

FIG. 6C is a cross-sectional view of the workpiece contact assembly of FIG. 5A along the line 6C-6C of FIG. 5B.

FIG. 7A is a perspective view of a magazine assembly of the powered fastener driver of FIG. 1A and including a pusher assembly.

FIG. 7A-1 is a perspective view of the pusher assembly of FIG. 7A.

FIG. 7A-2 is a cross-sectional view of the pusher assembly of FIG. 7A.

FIG. 7B is cross-sectional view of the magazine assembly and the nosepiece of FIG. 1A.

FIG. 7C is a detailed perspective view of a latch mechanism for use with the magazine assembly of FIG. 7A in an engaged position.

FIG. 7D is a detailed perspective view of the latch mechanism of FIG. 7C in a disengaged position.

FIG. 7E is another detailed perspective view of the latch mechanism of FIG. 1A.

FIG. 8A is a perspective view of a kickstand of the powered fastener driver of FIG. 1A.

FIG. 8B is another perspective view of the kickstand of FIG. 8A.

FIG. 8C is a detailed perspective view of the magazine assembly of FIG. 7A.

FIG. 9A is a perspective view of a dry fire lockout system of the powered fastener driver of FIG. 1A and a light assembly.

FIG. 9A-1 is a detailed perspective view of the dry fire lockout system of the powered fastener powered fastener driver and the light assembly of FIG. 9A.

FIG. 9A-2 is a detailed perspective view of another light assembly for use with the powered fastener driver of FIG. 1A.

FIG. 9B is schematic view of a portion of the dry fire lockout system of FIG. 9A in a first position.

FIG. 9C is schematic view of a portion of the dry fire lockout system of FIG. 9A in a second position.

FIG. 9D is a schematic view of another dry-fire lockout system suitable for use with the powered fastener driver of FIG. 1A, the dry-fire lockout system including a spring-biased plunger in a first position.

FIG. 9E is a schematic view of the dry-fire lockout system of FIG. 9D with the spring-biased plunger in a second position.

FIG. 9F is a schematic view of another dry-fire lockout system suitable for use with the powered fastener driver of FIG. 1A, the dry-fire lockout system including a spring-biased plunger in a first position.

FIG. 9G is a schematic view of the dry-fire lockout system of FIG. 9F with the spring-biased plunger in a second position.

FIG. 9H is a schematic view of a portion of the dry-fire lockout system of FIG. 9F.

FIG. 9I is a schematic view of a portion of the dry-fire lockout system of FIG. 9F.

FIG. 9J is a schematic view of a portion of the dry-fire lockout system of FIG. 9F.

FIG. 10 is a side view of the plurality of fasteners and a collation including a plurality of receptacles, each of the plurality of receptacles retaining one of the plurality of fasteners, the collation and fasteners configured to be used with the powered fastener driver of FIG. 1.

FIG. 11A is a side perspective view of one of the plurality of receptacles of the collation of FIG. 10.

FIG. 11B is another side perspective view of the receptacle of FIG. 11A.

FIG. 11C is another side perspective view of the receptacle of FIG. 11A.

FIG. 11D is another side perspective view of the receptacle of FIG. 11A.

FIG. 11E is a first side view of the receptacle of FIG. 11A.

FIG. 11F is a second side view of the receptacle of FIG. 11A.

FIG. 11G is a front view of the receptacle of FIG. 11A.

FIG. 11H is a rear view of the receptacle of FIG. 11A.

FIG. 12A illustrates another pusher assembly for use with the magazine assembly of FIG. 7A and including an actuator and a pusher finger.

FIG. 12B is a schematic view of the actuator of FIG. 12A in an unlocked position.

FIG. 12C is a schematic view of the actuator of FIG. 12A in a locked position.

FIG. 12D is a schematic view of the pusher finger of FIG. 12A in an engaged position.

FIG. 12E is a schematic view of the pusher finger of FIG. 12A in a bypass position.

FIG. 12F is a detailed schematic view of the pusher finger in the bypass position.

FIG. 13A is a side view of the plurality of fasteners and a collation including a plurality of receptacles having another configuration, each of the plurality of receptacles retaining one of the plurality of fasteners, the collation and fasteners configured to be used with the powered fastener driver of FIG. 1.

FIG. 13B is a detailed side view of one of the plurality of receptacles of FIG. 13A.

FIG. 13C is another detailed side view of one of the plurality of receptacles of FIG. 13A.

FIG. 14A is a side view of the plurality of fasteners and a collation including a plurality of receptacles having another configuration, each of the plurality of receptacles retaining one of the plurality of fasteners, the collation and fasteners configured to be used with the powered fastener driver of FIG. 1.

FIG. 14B is a detailed side view of one of the plurality of receptacles of FIG. 14A.

FIG. 14C is another detailed side view of one of the plurality of receptacles of FIG. 14A.

FIG. 15A is a side view of the plurality of fasteners and a collation including a plurality of receptacles having another configuration, each of the plurality of receptacles retaining one of the plurality of fasteners, the collation and fasteners configured to be used with the powered fastener driver of FIG. 1.

FIG. 15B is a detailed side view of one of the plurality of receptacles of FIG. 15A.

FIG. 15C is another detailed side view of one of the plurality of receptacles of FIG. 15A.

FIG. 16A is a side view of the plurality of fasteners and a collation including a plurality of receptacles having another configuration, each of the plurality of receptacles retaining one of the plurality of fasteners, the collation and fasteners configured to be used with the powered fastener driver of FIG. 1.

FIG. 16B is a detailed side view of one of the plurality of receptacles of FIG. 16A.

FIG. 16C is another detailed side view of one of the plurality of receptacles of FIG. 16A.

FIG. 17A is a side view of the plurality of fasteners and a collation including a plurality of receptacles having another configuration, each of the plurdality of receptacles retaining one of the plurality of fasteners, the collation and fasteners configured to be used with the powered fastener driver of FIG. 1.

FIG. 17B is a detailed side view of one of the plurality of receptacles of FIG. 17A.

FIG. 17C is another detailed side view of one of the plurality of receptacles of FIG. 17A.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

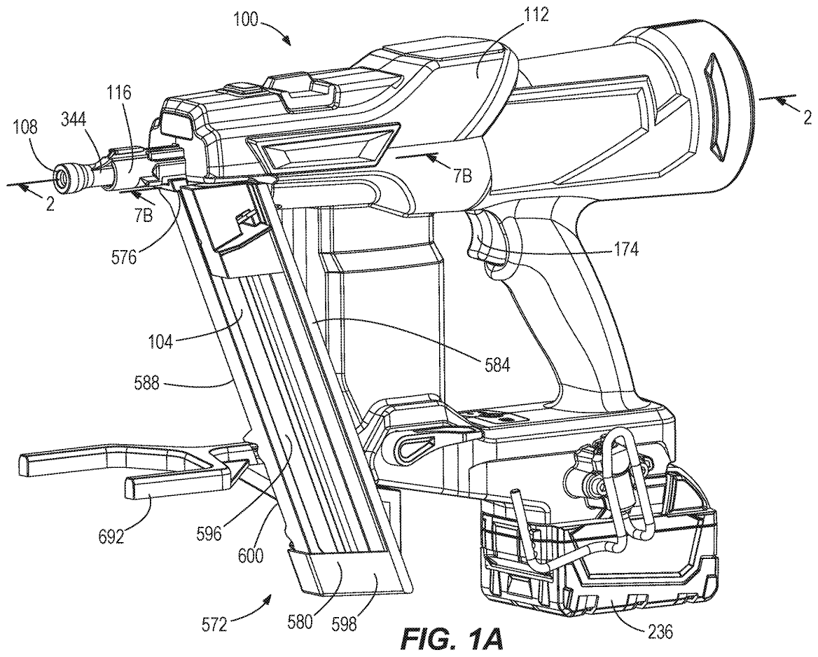

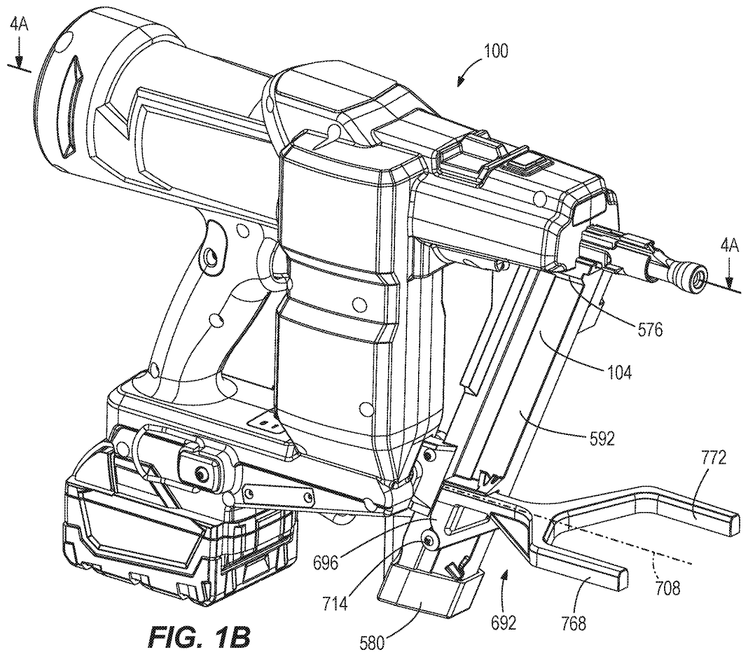

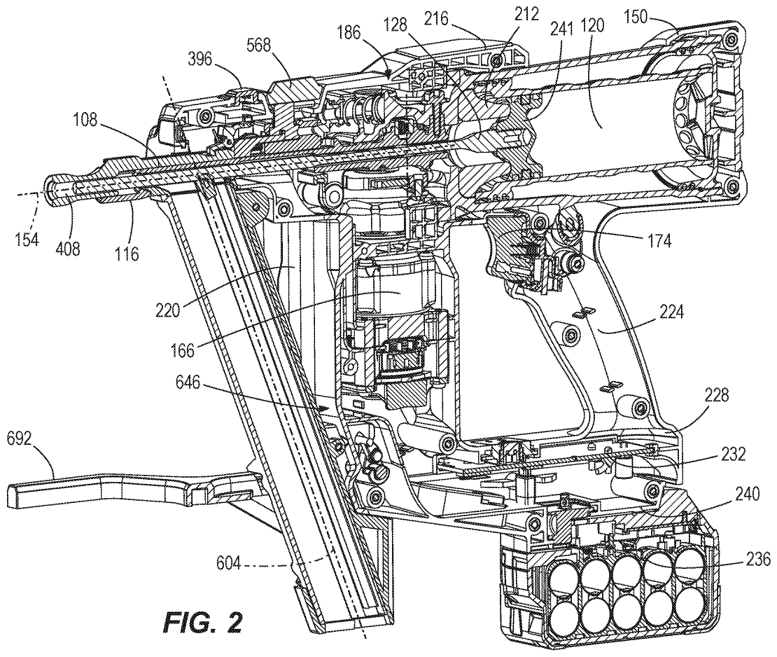

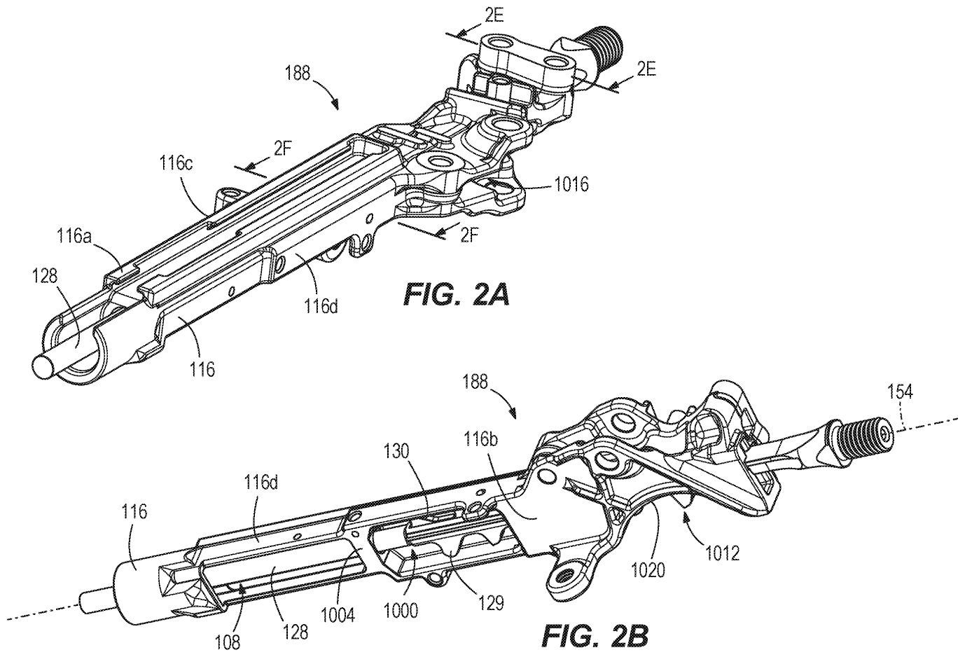

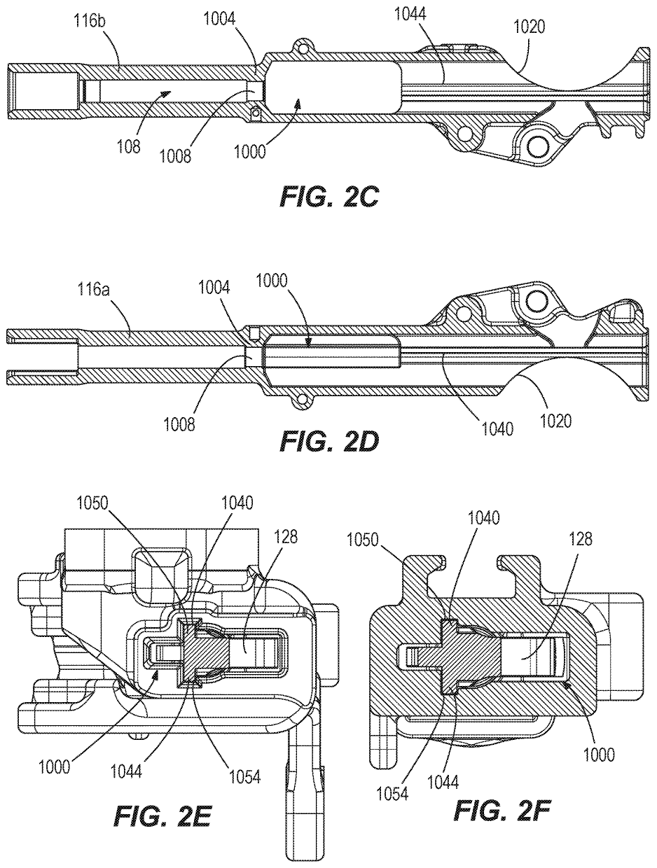

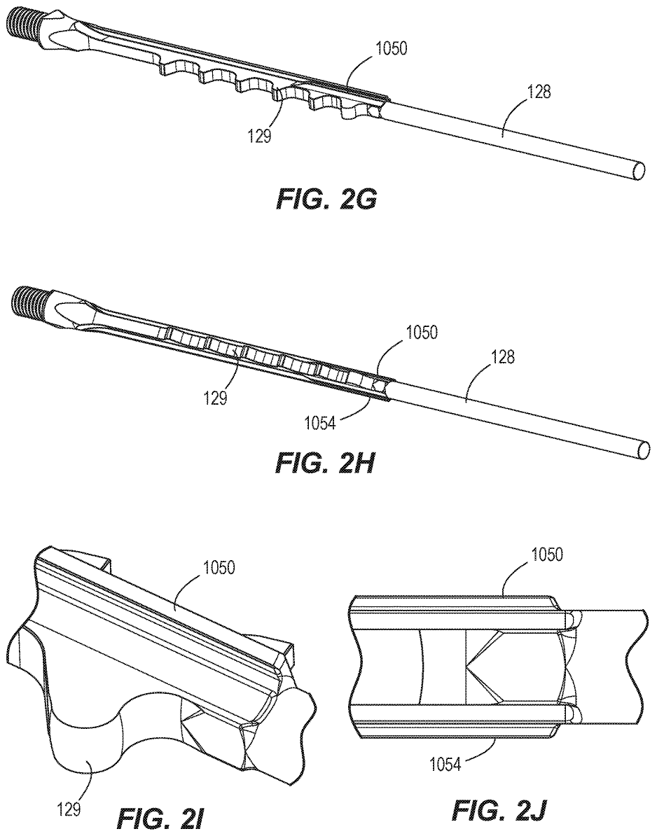

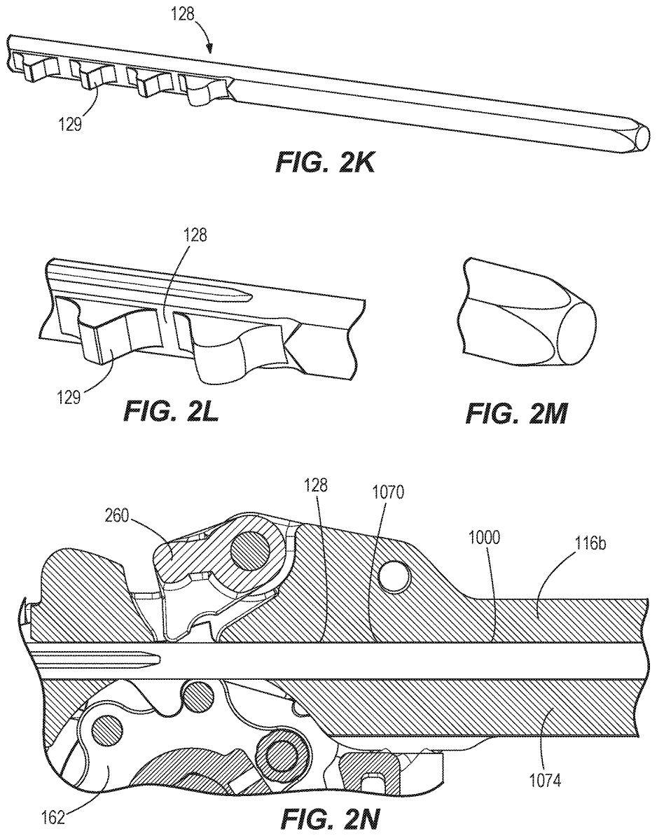

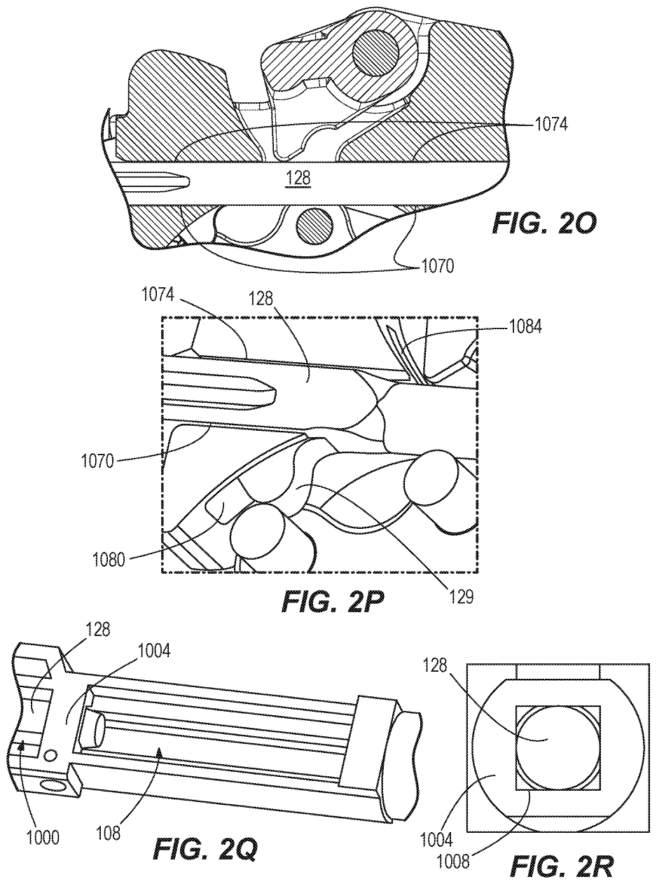

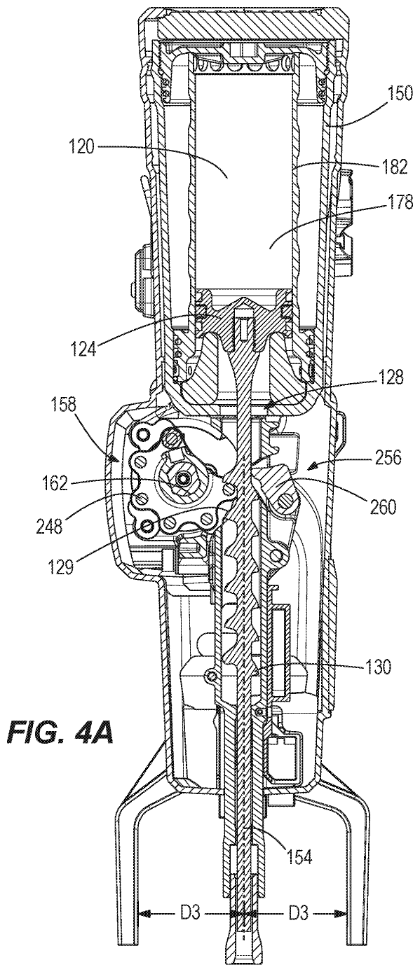

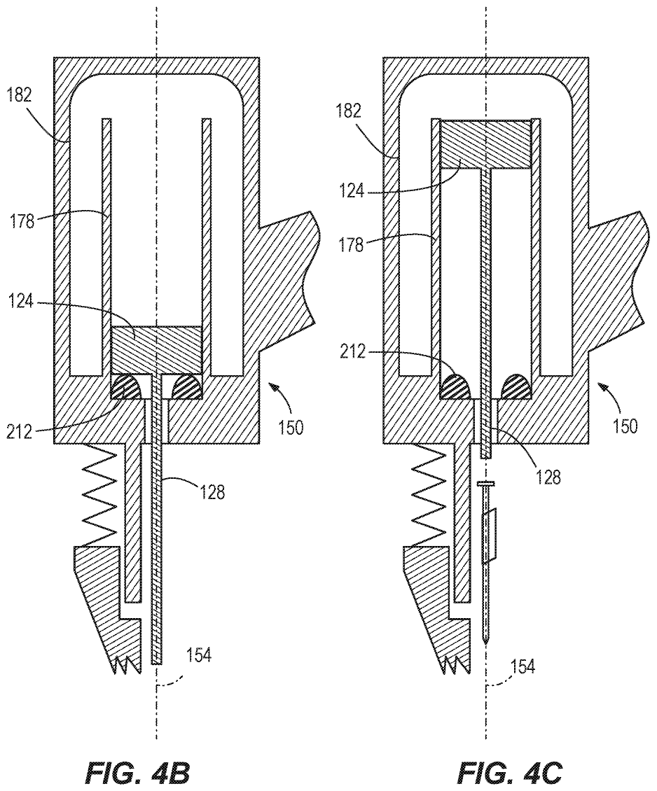

With reference to FIGS. 1A-2 a gas spring-powered fastener driver 100 is operable to drive fasteners (e.g., nails, tacks, staples, etc.) held within a magazine assembly 104 along a fastener driving channel 108 into a workpiece. The fastener driver 100 includes a housing 112 and a nosepiece 116 coupled to the housing. The nosepiece 116 is coupled to the magazine assembly 104 and at least partially defines the fastener driving channel 108. As shown in FIG. 2, an inner cylinder 120 is positioned within the housing 112 and a moveable piston 124 is positioned within the inner cylinder 120. The fastener driver 100 further includes a driver blade 128 that is attached to the piston 124 and moveable therewith. As shown in FIG. 4A, the driver blade 128 has lifter teeth 129 extending from one side and latch teeth 130 extending from an opposite side. The fastener driver 100 does not require an external source of air pressure, but rather includes an outer storage chamber cylinder 150 of pressurized gas in fluid communication with the inner cylinder 120. In the illustrated embodiment, the inner cylinder 120 and moveable piston 124 are positioned within the storage chamber cylinder 150. The driver 100 further includes a fill valve (not shown) coupled to the storage chamber cylinder 150. When connected with a source of compressed gas, the fill valve permits the storage chamber cylinder 150 to be refilled with compressed gas if any prior leakage has occurred. The fill valve may be configured as a Schrader valve, for example.

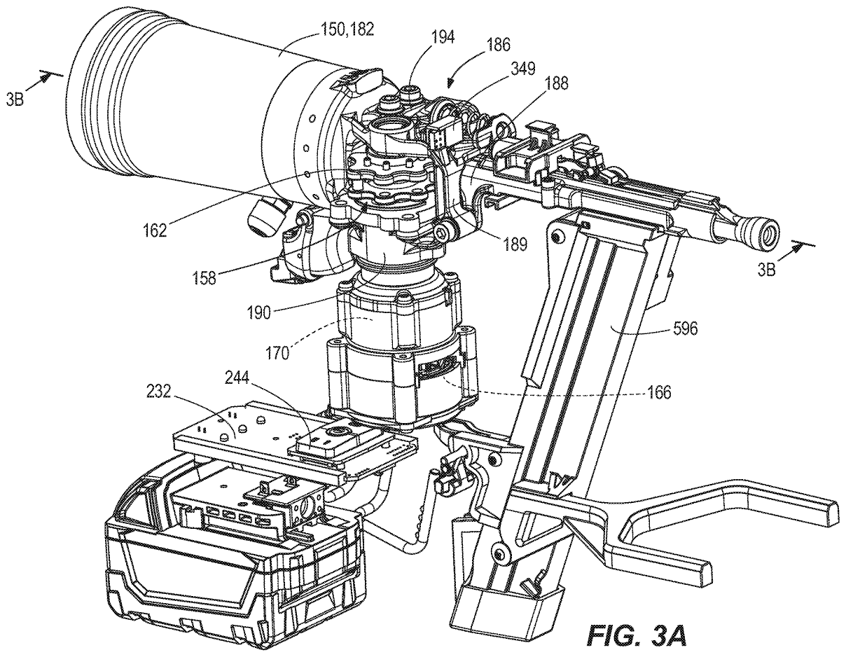

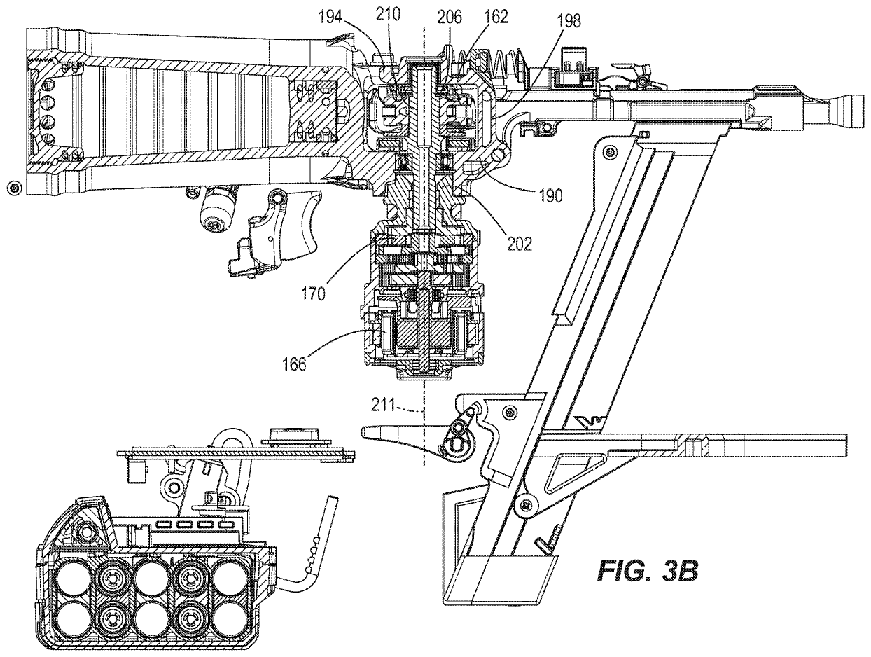

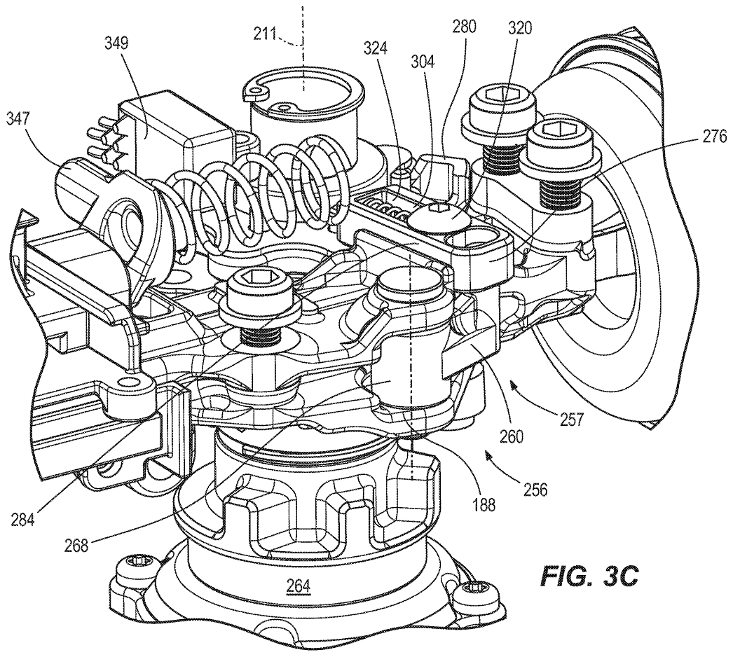

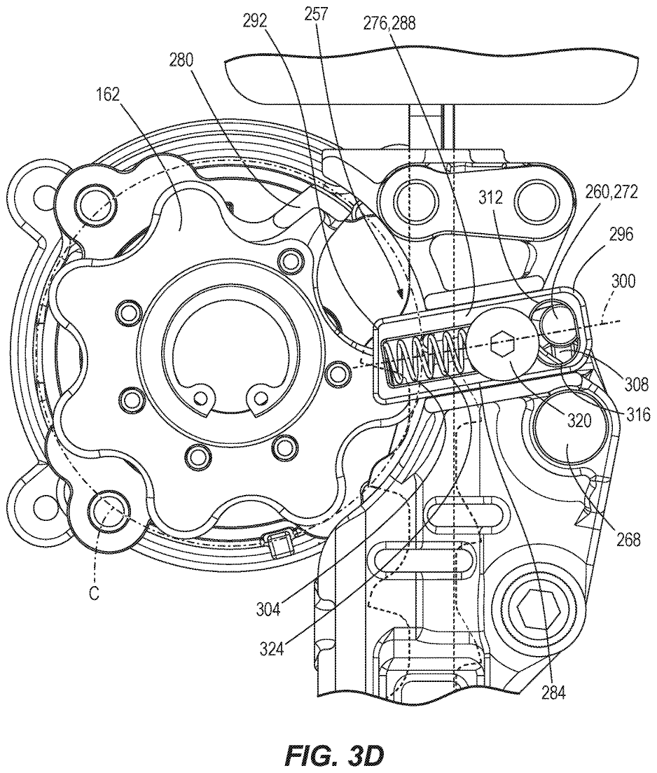

With reference to FIGS. 2 and 4A-4C, the inner cylinder 120 and the driver blade 128 define a driving axis 154. The driving axis 154 extends through fastener driving channel 108. During a driving cycle, the driver blade 128 and piston 124 are moveable between a top-dead-center (TDC) position (FIG. 4C) and a driven or bottom-dead-center (BDC) position (FIG. 4B). With respect to FIGS. 2, 3A, 3B and 4A, the fastener driver 100 further includes a lifting assembly 158 (FIG. 3A), which has a lifter 162 that is powered by a motor 166 (FIGS. 2 and 3B) and that moves the driver blade 128 from the driven position to the TDC position. The motor 166 provides torque to a transmission 170 (FIG. 3B), when activated. The transmission 170 provides torque to the lifter 162 from the motor 166. As described below in further detail, the transmission 170 thus raises the driver blade 128 from the driven position to a ready position.

In operation, the lifting assembly 158 drives the piston 124 and the driver blade 128 toward the TDC position by energizing the motor 166. As the piston 124 and the driver blade 128 are driven toward the TDC position, the gas above the piston 124 and the gas within the storage chamber cylinder 150 is compressed. Prior to reaching the TDC position, the motor 166 is deactivated and the piston 124 and the driver blade 128 are held in the ready position, which is located between the TDC and the BDC or driven positions, until being released by user activation of a trigger 174 (FIG. 1). When released, the compressed gas above the piston 124 and within the storage chamber cylinder 150 drives the piston 124 and the driver blade 128 to the driven position, thereby driving a fastener into the workpiece. The illustrated fastener driver 100 therefore operates on a gas spring principle utilizing the lifting assembly 158 and the piston 124 to further compress the gas within the inner cylinder 120 and the storage chamber cylinder 150. Further detail regarding the structure and operation of the fastener driver 100 is provided below.

With reference to FIGS. 2 and 4A, the storage chamber cylinder 150 surrounds the inner cylinder 120. As shown in FIG. 4A, the inner cylinder 120 has an annular inner wall 178 configured to guide the piston 124 and driver blade 128 along the driving axis 154 to compress the gas in the storage chamber cylinder 150. The storage chamber cylinder 150 has an annular outer wall 182 circumferentially surrounding the annular inner wall 178. As such, the inner cylinder 120 is configured to be axially secured to the storage chamber cylinder 150.

As shown with respect to FIGS. 2 and 3A, the storage chamber cylinder 150 is integrally formed with (e.g., formed as one piece with) or is otherwise coupled to an inner frame 186 (e.g., inner housing). The inner frame 186 is integrally formed with and extends from the annular outer wall 182 of the storage chamber cylinder 150. The inner cylinder 120 is defined in part by the inner frame 186, as shown in FIG. 2. Specifically, the inner frame 186 defines a forward end of the inner cylinder 120. The inner frame 186 is also coupled to the nosepiece 116. As shown, the nosepiece 116 has a support portion 188 that is coupled to the inner frame 186. Moreover, the nosepiece 116 thus extends from the inner frame 186 through the housing 112 such that the nosepiece 116 projects from the housing 112. Further with respect to FIG. 3A, the inner frame 186 also supports, at least in part, the lifting assembly 158. The inner frame 186 is constructed from a material that is more robust than plastic, such as metal.

Further with respect to FIGS. 3A and 3B, the inner frame 186 includes a first portion 190 and a second portion 194 spaced apart from the first portion 190. In the illustrated embodiment, the first and second portions 190, 194 are coupled together by a third portion 198 that is spaced apart from the annular outer wall 182. The lifting assembly 158 is positioned between the first portion 190 and the second portion 194. Also, the lifting assembly 158 is positioned between the annular outer wall 182 and the third portion 198. The first portion 190 includes a first aperture 202 and the second portion 194 includes a second aperture 206 that is at least partially aligned with the first aperture 202. The first aperture 202 and the second aperture 206 are configured to receive an output shaft 210 of the transmission 170, which is operably coupled to the lifter 162. The output shaft 210 defines a rotational axis 211 of the lifter 162.

With reference to FIGS. 2 and 4B-4C, the fastener driver 100 includes a bumper 212 supported by the inner frame 186 and positioned beneath the piston 124 for stopping the piston 124 at the driven position (FIG. 4B) and absorbing the impact energy from the piston 124. The bumper 212 is configured to distribute the impact force of the piston 124 uniformly throughout the bumper 212 as the piston 124 is rapidly decelerated upon reaching the driven position (i.e., the BDC position).

With reference to FIG. 2, the housing 112 includes a cylinder support portion 216 in which the storage chamber cylinder 150 is at least partially positioned, a drive unit support portion 220 in which the motor 166 and the transmission 170 are at least partially positioned, a handle portion 224, and a battery support portion 228. Additionally, in the illustrated embodiment, the cylinder support portion 216 and the battery support portion 228 are spaced apart from one another and extend between the drive unit support portion 220 and the handle portion 224. Accordingly, the drive unit support portion 220 and the handle portion 224 are spaced apart from one another. In the illustrated embodiment, the cylinder support portion 216, the drive unit support portion 220, the handle portion 224, and the battery support portion 228 are integrally formed with one another as a single piece (e.g., using a casting or molding process, depending on the material used). The cylinder support portion 216 supports the inner frame 186 and partially covers the annular outer wall 182 of the storage chamber cylinder 150. Moreover, the housing 112 is formed from a plastic material. The inner frame 186 is thus made from a harder, stronger, more robust material (e.g., metal) than the material (e.g., plastic) used to form the housing 112. The housing 112 further supports a first printed circuit board 232. In the illustrated embodiment, the first printed circuit board 232 is at least partially supported by the battery support portion 228.

A battery pack 236 is received and supported by a battery pack attachment interface 240 of the handle portion 224. The battery pack 236 is electrically connectable to the motor 166 via a main electronic control unit 244 (FIG. 3A) of the first printed circuit board 232 for supplying electrical power to the motor 166. The main electronic control unit 244 receives power from the battery pack 236 and selectively routes it to the motor 166. In alternative embodiments, the driver 100 may be powered from an alternative power source such as an AC voltage input (i.e., from a wall outlet), or by an alternative DC voltage input (e.g., an AC/DC converter).

The main electronic control unit 244 may include, among other things, a processing unit (e.g., a microprocessor, a microcontroller, or another suitable programmable device) and a memory. The memory is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit is connected to the memory and executes software instructions that are capable of being stored in a RAM of the memory (e.g., during execution), a ROM of the memory (e.g., on a generally permanent basis), or another non-transitory computer readable medium such as another memory or a disc. Software included in the implementation of the fastener driver 100 can be stored in the memory of the main electronic control unit 244. The software includes, for example, an interrupt service routine (ISR), firmware, one or more applications, program data, filters, rules, one or more program modules, and other executable instructions. The main electronic control unit 244 is configured to retrieve from the memory and execute, among other things, instructions related to the control processes and methods described herein. In other embodiments, the electronic control unit 244 includes additional, fewer, or different components.

As noted above, the transmission 170 provides torque to the lifter 162 from the motor 166. The lifter 162 includes drive pins 248 (FIG. 4A) that are sequentially engageable with the lifter teeth 129 on one side of the driver blade 128 configured to raise the driver blade 128 from the BDC position to the TDC position. In the illustrated embodiment, a lowermost one of the lifter teeth 129 is configured to engage with the respective drive pin for maintaining the driver blade 128 in the ready position.

The operation of a firing cycle for the driver 100 is detailed below. With reference to FIG. 4C, prior to initiation a firing cycle, the driver blade 128 is held in the ready position with the piston 124 near TDC within the inner cylinder 120. Upon the trigger 174 being pulled to initiate a firing cycle, the motor 166 is activated to rotate the lifter 162 in a counterclockwise direction from the frame of reference of FIG. 4A, thereby displacing the driver blade 128 upward to the TDC position of the driver blade 128. Thereafter, the piston 124 and the driver blade 128 are thrust downward toward the driven position (FIG. 4B) by the expanding gas in the inner cylinder 120 and storage chamber cylinder 150. As the driver blade 128 is displaced toward the driven position, the motor 166 remains activated to continue counterclockwise rotation of the lifter 162. Upon a fastener being driven into a workpiece, the piston 124 impacts the bumper 212 to quickly decelerate the piston 124 and the driver blade 128, eventually stopping the piston 124 in the driven or BDC position. Shortly after the driver blade 128 reaches the driven position, continued counterclockwise rotation of the lifter 162 raises the driver blade 128 and the piston 124 toward the ready position. At this point, the lowermost of the lifter teeth 129 is in engagement with one of the drive pins 248 for holding the driver blade 128 in the ready position.

With reference to FIGS. 3C and 3D, the driver further includes a latch assembly 256 having a pawl or latch 260 for selectively holding the driver blade 128 in an intermediate position located between the BDC position and the ready position against a biasing force (i.e., the pressurized gas in the storage chamber 30) (i.e., for clearing a jam, etc.). The intermediate position may be any position at which the driver blade 128 stops between the BDC position and the ready position. A separate actuator 257, as further discussed below, is provided for releasing the latch assembly 256 from the driver blade 128. In other words, the latch assembly 256 is moveable between a latched state in which the driver blade 128 is held in the intermediate position (e.g., for clearing a jam, etc.), and a released state in which the driver blade 128 is permitted to be driven by the biasing force toward the driven position.

The latch 260 is movably supported by the support portion 188 of the nosepiece 116. The latch 260 is rotatable about a pivot axis 264 defined by a shaft 268 of the latch assembly 256. The pivot axis 264 is parallel to the rotational axis 211 of the lifter 162. The latch 260 includes a protrusion 272 extending therefrom, as further discussed below.

The latch 260 is moveable between a latched position (coinciding with the latched state of the latch assembly 256) in which the latch 260 is engaged with one of the latch teeth 130 on the driver blade 128 for holding the driver blade 128 in the intermediate position, and a released position (coinciding with the released state of the latch assembly 256) in which the latch 260 is moved away from the driver blade 128 to permit the driver blade 128 to be driven by the gas spring from the intermediate position to the driven position.

FIG. 3D illustrates one embodiment of the actuator 257 of the latch assembly 256 for selectively releasing the latch 260 from the driver blade 128. The actuator 257 is referred to herein as a latch actuator assembly 257. In particular, the latch actuator assembly 257 is integrated with the lifting assembly 158 (e.g., the lifter 162) for selectively moving the latch 260 from the latched position to the released position. The latch assembly 256 is mechanically operated by the latch actuator assembly 257, rather than electrically operated such as via a solenoid, for controlling the movement of the latch 260.

The latch actuator assembly 257 is positioned proximate the lifter 162 and forward of the driver blade 128 (e.g., above the driver blade 128 from the frame of reference of FIG. 3D). The inner frame 186 surrounds the latch actuator assembly 257, as shown in FIG. 2. The latch actuator assembly 257 includes a follower 276 and a cam member 280. The follower 276 is operatively coupled between the lifter 162 and the latch 260. The latch actuator assembly 257 is supported by the support portion 188 of the nosepiece 116. As shown, the follower 276 is movable (e.g., slidable) within a slot 284 of the support portion 188. The slot 284 defines a sliding axis 300 (FIG. 3D) extending at an oblique angle relative to the driving axis 154.

The follower 276 includes a body 288 extending between a first end 292 and a second end 296. The body 288 is oriented parallel to a sliding axis 300. The body 288 further defines a first elongated slot 304 and a second elongated slot 308. The first elongated slot 304 extends along the sliding axis 300. The second elongated slot 308 is positioned between the first elongated slot 304 and the second end 296 of the follower 276. The second elongated slot 308 extends perpendicular to the sliding axis 300 between a first end 312 and a second, opposite end 316.

As shown in FIG. 3C, the connector 320 (e.g., fastener, such as a screw) and a biasing member 324 (e.g., compression spring) are received within the first elongated slot 304. The connector 320 movably supports the follower 276 on the support portion 188 of the nosepiece 116. More specifically, the connector 320 is fixedly coupled to the nosepiece 116, and the follower 276 is movable relative to the connector 320 along the sliding axis 300. The connector 320 is configured to inhibit or prevent movement of the follower 276 in a direction parallel to the pivot axis 264 (e.g., upward, and downward from the frame of reference of FIG. 3C). The biasing member 324 extends between the connector 320 and an end of the first elongated slot 304 that is proximate the first end 292 of the body 288 (and the lifter 162). The biasing member 324 is configured to bias the follower 276 toward the lifter 162. The second elongated slot 308 receives the protrusion 272 of the latch 260. The second elongated 308 slot is sized such that the protrusion 272 is engageable with and movable relative to the follower 276.

The cam member 280 is coupled for co-rotation with the lifter 162 of the lifting assembly 158. In the illustrated embodiment, the cam member 280 is integral with the lifter 162. In other embodiments, the cam member 280 may be separate from the lifter 162. The cam member 280 has a surface that protrudes outwardly from the lifter 162. More specifically, with reference to FIG. 3D, the lifter 162 defines a circumference C, and the cam member 280 extends radially outward relative to the rotational axis 211 (which is into the page from the perspective of FIG. 3D) of the lifter 162 past the circumference C defined by the lifter 162. A size of the circumference C is selected for allowing the engagement between the drive pins 248 of the lifter 162 and the lifter teeth 129 of the driver blade 128. In other embodiments, the cam member 280 or portions thereof is positioned on or radially inward of the circumference C. In addition, the cam member 280 is positioned forward of the lifter 162 (e.g., above from the frame of reference of FIG. 3C) such that the cam member 280 is positioned forward of the driver blade 128 and aligned with the first end 292 of the follower 276. The cam member 280 is located at a predetermined circumferential location about the circumference C such that the cam member 280 is configured to selectively engage the first end 292 of the follower 276 for moving the follower 276, and thereby the latch 260, from the latched position to the released position.

In particular, when the lifter 162 is returning the driver blade 128 toward the TDC position, the biasing member 324 is configured to bias the follower 276 toward the lifter 162, and the protrusion 272 is positioned proximate the first end 312 of the second elongated slot 308, thereby positioning the latch 260 is in the latched position, as shown in FIG. 3D. As the driver blade 128 approaches the TDC position, the cam member 280 is located at the predetermined circumferential location to engage the follower 276, and moves the follower 276, and thereby the latch 260 from the latched position toward the released position against the bias of the biasing member 324. More specifically, as the lifter 162 rotates (to move the driver blade 128 from the ready position to the TDC position), the cam member 280 is configured to linearly move the follower 276 along the sliding axis 300 away from the lifter 162. Concurrently, the second elongated slot 308 is configured to engage the protrusion 272 of the latch 260 as the follower 276 moves to pivot the latch 260 about the pivot axis 264 from the latched position toward the released position. In addition, the second elongated slot 308 moves relative to the protrusion 272, with the movement of the follower 276, to locate the protrusion 272 closer to the second end 316 of the second elongated slot 308.

When the protrusion 272 is positioned at the second end 316 within the second elongated slot 308, the driver blade 128 is at the TDC position and the latch 260 has been pivoted completely out of the way of the driver blade 128, and subsequently the driver blade 128 is configured to be driven from the TDC position to the BDC position by the gas spring. The lifter 162 continues to rotate to return the driver blade 128 from the BDC position toward the ready position such that the cam member 280 is configured to rotate past and disengage from the follower 276. The follower 276 is moved toward the lifter 162 again by the bias of the biasing member 324 after the cam member 280 has completely disengaged from the follower 276. The second elongated slot 308 moves relative to the protrusion 272, thereby repositioning the protrusion 272 proximate the first end 312 of the second elongated slot 308, and the latch 260 is again in the latched position. As such, the movement of the latch 260 between the latched position and the released position is based on the predetermined circumferential location of the cam member 280 as the lifter 162 rotates through a firing cycle. Furthermore, the latch actuator assembly 257 is configured to adjust rotational movement of the lifter 162 into select pivoting movement of the latch 260 via a linear sliding movement of the latch actuator assembly 257.

In operation, the lowermost one of the lifter teeth 129 is in engagement with one of the drive pins 248 for holding the driver blade 128 in the ready position. In addition, when the driver blade 128 is in the ready position, the latch 260 is in contact with (e.g., resting on) a lowermost one of the latch teeth 130. As the driver blade 128 moves from the ready position toward the TDC position, the latch 260 first moves toward and contacts the second side of the driver blade 128 before moving away from the driver blade 128 toward the released position. The latch 260 is moved completely out of the way as the driver blade 128 reaches the TDC position. The cam member 280 is shaped to maintain the latch 260 in the released position as the driver blade 128 moves from the TDC position to the BDC position.

With respect to FIGS. 2A-2B, 3C, and 4A, in addition to the fastener driving channel 108 and the support portion 188, the nosepiece 116 includes a front wall 116a, a rear wall 116b, a first side wall 116c, a second side wall 116d opposite the first side wall 116c, and a guide channel 1000 that is aligned with the fastener driving channel 108 along the driving axis 154. The guide channel 1000 is separated from the fastener driving channel 108 by a wall 1004 and configured to movably receive the lifter teeth 129 and the latch teeth 130 of the driver blade 128. As shown, the driver blade 128 has a driving portion that defines a tip that engages each fastener and a toothed portion that is spaced apart from the tip. The toothed portion includes the lifter teeth 129 and the latch teeth 130. The toothed portion has a larger cross-sectional dimension than the driving portion. Thus, only the driving portion is received within the fastener driving channel 108 through an aperture 1008 in the wall 1004.

As shown in FIGS. 2B and 3C, the nosepiece 116 (e.g., the support portion 188 thereof) has openings 1012, 1016 extending through each of the first and second side walls 116c, 116d, and the openings 1012, 1016 are in communication with the guide channel 1000. The first side wall 116c includes a generally curved or arcuate cutout 1020 (FIGS. 2B-2D). The opening 1012 in the first side wall 116c extends through the cutout 1020. The cutout 1020 is positioned in the support portion 188. The cutout 1020 is sized and shaped to receive the lifter 162, such that the lifter 162 is able to engage the lifter teeth 129 of the driver blade 128 through the corresponding opening 1012. As noted above, the latch 260 is supported by the support portion 188 and positioned between the front wall 116a and the rear wall 116b. The latch 260 is adjacent the opening 1016 in the second side wall 116d, such that latch 260 is able to engage the latch teeth 130 of the driver blade 128.

With respect to FIGS. 2C-2F, the guide channel 1000 is formed, at least in part, by the front wall 116a of the nosepiece 116, the rear wall 116b of the nosepiece 116, and the separating wall 1004. In the illustrated embodiment, each of the front wall 116a and the rear wall 116b includes a groove 1040, 1044 in an inner surface thereof that is oriented parallel to the driving axis 154. The grooves 1040, 1044 each open to the guide channel 1000 and each is configured to receive a projection 1050, 1054 of the driver blade 128. As shown in FIGS. 2G-2J, the lifter teeth 129 extend from a first side, the latch teeth 130 extend from a second side, a first projection 1050 extends from a front side, and a second projection 1054 extends from a rear side. Thus, the first projection 1050 is configured to be received in the groove 1040 of the front wall 116a and the second projection 1054 is configured to be received in the groove 1044 of the rear wall 116b. In other embodiments, either of the grooves 1040, 1044 may be included while and the other is omitted, and either the first or the second projection 1050, 1054 may be included while the other is omitted. Moreover, in other embodiments, the grooves 1040, 1044 may be in the driver blade 128 while the projections 1050, 1054 extend from the walls 116a, 116b. Regardless, in the embodiment of FIGS. 2A-2J, the driver blade 128 is keyed to the front and rear walls 116a, 116b of the guide channel 1000 to prevent from the driver blade 128 from twisting as it moves along the driving axis 154. More specifically, the driver blade 128 is prevented from twisting as it moves along the driving axis 154 due to the receipt of the projections 1050, 1054 within the grooves 1040, 1044.

In the embodiment of FIGS. 2K-2R, the driver blade 128 is keyed to the nosepiece 116 but in a different way. The embodiment of FIGS. 2K-2R is similar to that of FIGS. 2A-2J. Thus, like reference numerals will be used for like structure and only differences discussed. As shown, a body of the driver blade 128 includes a generally polygonal cross-section. In the illustrated embodiment, the cross-section of the body is square, but in other embodiments the cross-section may have other shapes (which are non-circular). Moreover, the guide channel 1000 has first and second side walls 1070, 1074 that are configured to engage or be positioned adjacent to the first and second sides of the body of the driver blade 128 on opposite sides (e.g., in the front and rear) of the lifter teeth 129 and latch teeth 130. Moreover, the nosepiece 116 includes slots 1080, 1084 that are on opposite sides of the guide channel 1000 and that communicate with the same for receiving the lifter teeth 129 and the latch teeth 130, respectively. Even further, the aperture 1008 in the wall has a cross-sectional shape that matches the cross-sectional shape of the body of the driver blade 128. Thus, in the embodiment of FIGS. 2K-2R, the driver blade 128 is keyed to walls 1070, 1074 of the guide channel 1000 to prevent from the driver blade 128 from twisting as it moves along the driving axis 154 and aperture 1008 of the wall 1004.

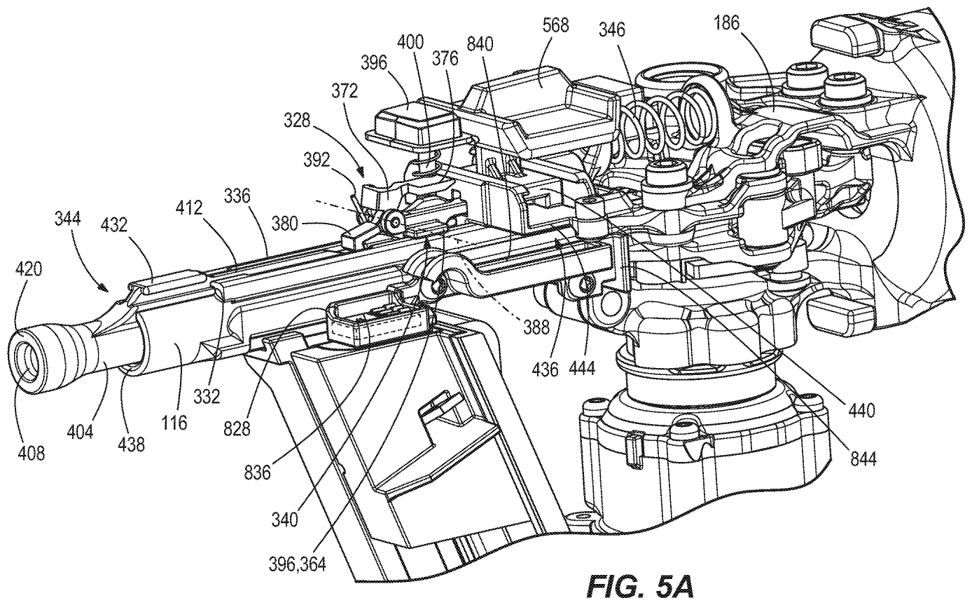

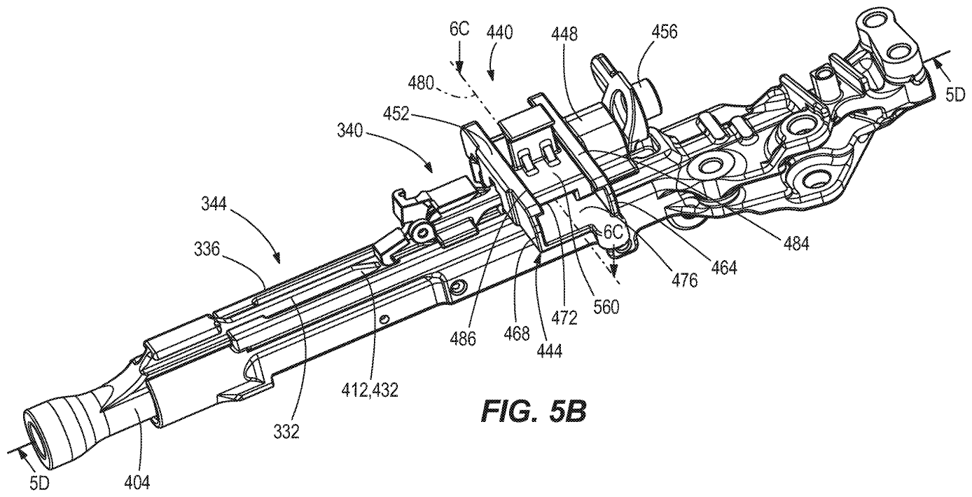

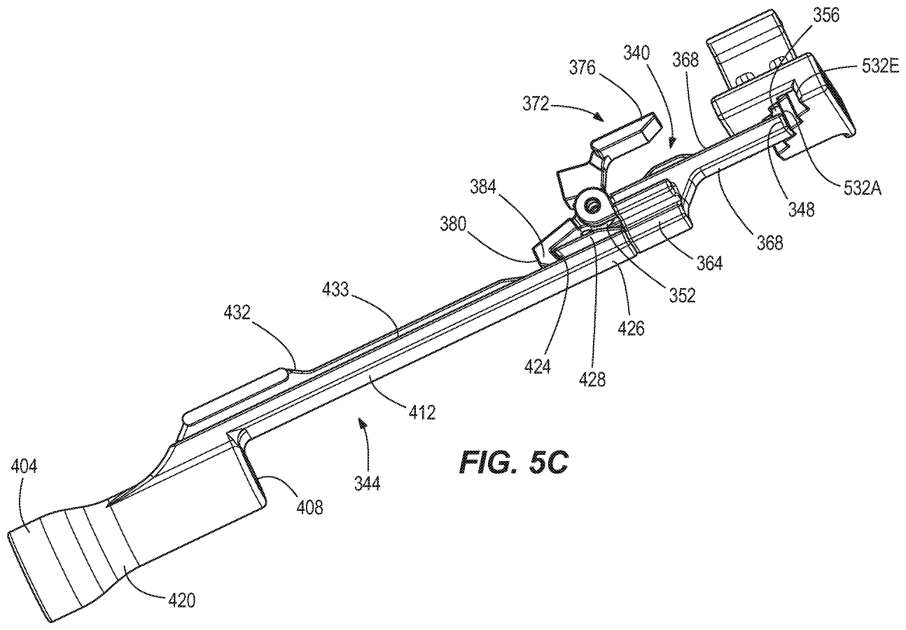

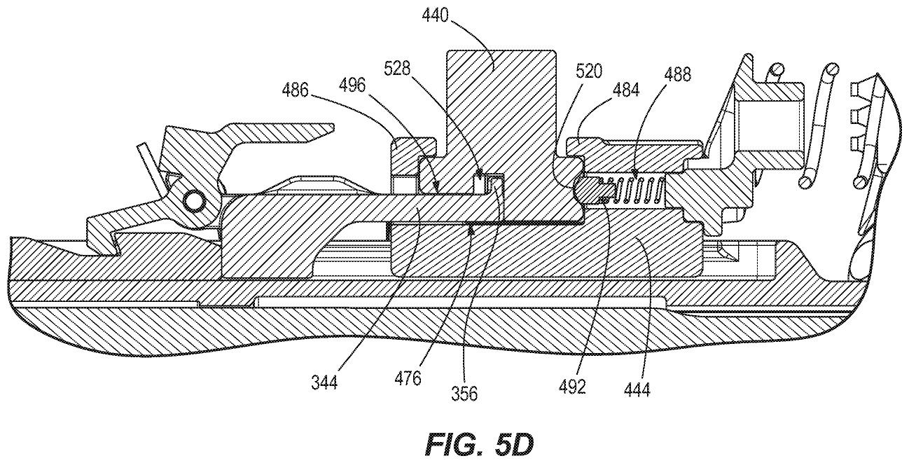

With reference to FIG. 5A, the fastener driver 100 includes a workpiece contact assembly 328 that is slidably engaged with the nosepiece 116. The nosepiece 116 further includes an auxiliary channel 332 that is distinct from the fastener driving channel 108. In this case, the auxiliary channel 332 in front of the fastener driving channel 108. The auxiliary channel 332 is parallel to the fastener driving channel 108. A slot 336 extends through the front wall 116a of the nosepiece 116 and extends parallel to the auxiliary channel 332. The slot 336 is in communication to the auxiliary channel 332. The workpiece contact assembly 328 is at least partially received within and slidable relative to the auxiliary channel 332 and extends through the slot 336.

The workpiece contact assembly 328 includes an upper workpiece contact member 340 and a lower workpiece contact member 344. In the illustrated embodiment, the lower workpiece contact member 344 may be removed from the upper workpiece contact member 340, as discussed in greater detail below. The workpiece contact assembly 328 is movable from an extended position to a retracted position when the lower workpiece contact member 344 is in contact with the workpiece. A biasing member 346 (such as a compression spring) biases the workpiece contact assembly 328 into the extended position. In the illustrated embodiment, the workpiece contact assembly 328 includes a detector 347 (e.g., a metal member). A sensor 349, such an inductive sensor, is supported on the inner frame 186 and configured to detect the position of the detector 347. The sensor 349 is in electrical communication with the main electronic control unit 244. In the extended position, a gap between the detector 347 and the sensor 349 is greater than a predetermined distance and the sensor 349 will not be triggered. In the retracted position, a gap between the detector 347 and the sensor 349 is less than or equal to the predetermined distance and the sensor 349 will be triggered. When triggered, the sensor 349 sends an output control signal to the main electronic control unit 244 indicating that the workpiece contact assembly 328 is in the retracted position. In response to the output control signal of the sensor 349 and an output control signal sent in response to actuation of the trigger 174, the main electronic control unit 244 activates the motor 166 with power from the battery pack 236.

With respect to FIG. 5C, the upper workpiece contact member 340 includes a first end 348 and a second end 352 opposite the first end 348. The upper workpiece contact member 340 includes a first projection 356 extending from a front surface 360 and a second projection 364 extending from a rear surface 368. The first projection 356 and the second projection 364 extend transverse to the driving axis 154. The second projection 364 is generally T-shaped and configured to be slidably received within the auxiliary channel 332 of the nosepiece 116 and extend through the slot 336.

A latch 372 is pivotably coupled to the second end 352 of the upper workpiece contact member 340. The latch 372 includes a first end 376 and a second end 380 opposite the first end 376. The second end 380 has a projection 384. The latch 372 is pivotably coupled to the upper workpiece contact member 340 at a location between the first end 376 and the second end 380 of the latch 372. Thus, a pivot axis 388 (FIG. 5A) of the latch 372 is between the first end 376 and the second end 380 thereof. The latch 372 is pivotable between a latched position and a released position. A biasing member 392 (FIG. 5A), such as a torsion spring, biases the latch 372 into the latched position.

An actuator 396 is accessible from outside the housing 112 and is configured to move the latch 372 from the latched position to the released position. A biasing member 400 such as a compression spring, biases the actuator 396 away from engagement with the latch 372. The biasing member 400 is positioned between the first end 376 of the latch 372 and the actuator 396.

With respect to FIGS. 5A-5C, the lower workpiece contact member 344 includes a barrel 404 with a channel 408 that partially defines the fastener driving channel 108. The channel 408 defines an inner diameter. An arm 412 is integrally formed with and extends from the barrel 404. The arm 412 defines a first end 416 of the lower workpiece contact member 344 and the barrel 404 defines a second end 420 of the lower workpiece contact member 344. The arm includes a groove 424 at the first end 416. In the illustrated embodiment, the arm 412 includes a first projection 428 and a second projection 432 extending from a front surface 433 thereof. The groove 424 is defined by the first projection 428. The arm 412 is received within and slidable relative to the auxiliary channel 332, with the projections 428, 432 extending through the slot 336.

In the latched position the projection 384 of the latch 372 is positioned within the groove 424 and couples the lower workpiece contact member 344 to the upper workpiece contact member 340. In the released position, the projection 384 is spaced apart from the groove 424, allowing the lower workpiece contact member 344 to be removed from the upper workpiece contact member 340 and therefore, the nosepiece 116. The lower workpiece contact member 344 can be replaced with an alternative lower workpiece contact member (not shown). For example, in some embodiments, the alternative lower workpiece contact member may include a channel having a different size, allowing fastener driver 100 to fire fasteners of different sizes. In still other embodiments, the alternative lower workpiece contact member may have other configurations and features that are not part of the lower workpiece contact member 344. To remove the lower workpiece contact member 344, the user actuates the actuator 396 against the bias of the spring 400, which in turn applies a force on the latch 372, causing the latch 372 to pivot into the released position against the bias of the spring 392. The user can then remove the lower workpiece contact member 344 and replace it with another lower workpiece contact member of a different size. For example, a first lower workpiece contact member 344 having a barrel 404 with a channel 408 with a first inner diameter can be replaced by a second lower workpiece contact member 344 having a barrel 404 with a channel 408 with a second inner diameter that is smaller or larger than the first inner diameter. In other embodiments the latch 372 may be pivotably coupled to the lower workpiece contact member 344 and the groove 424 may be on the upper workpiece contact member 340.

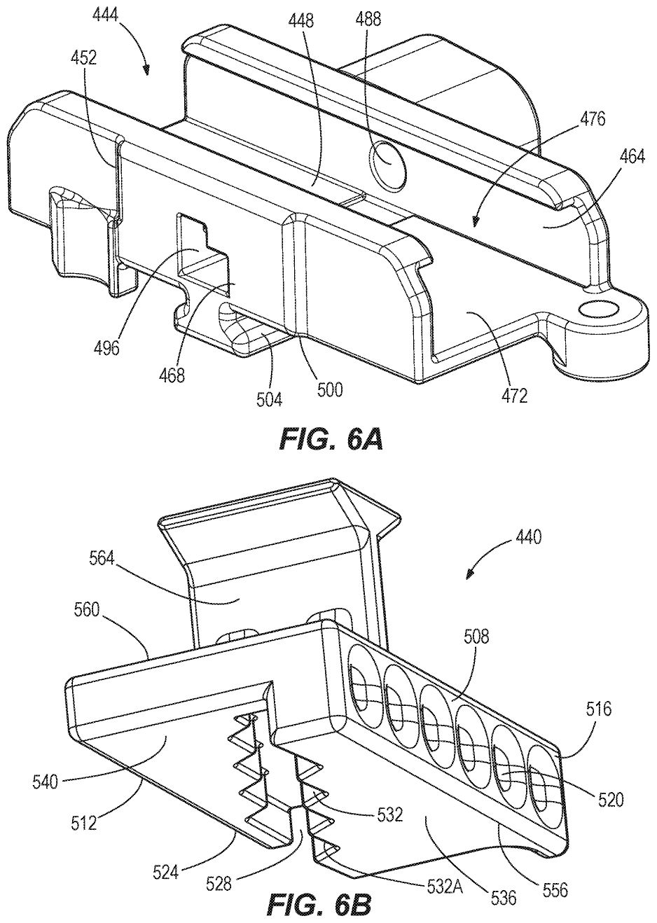

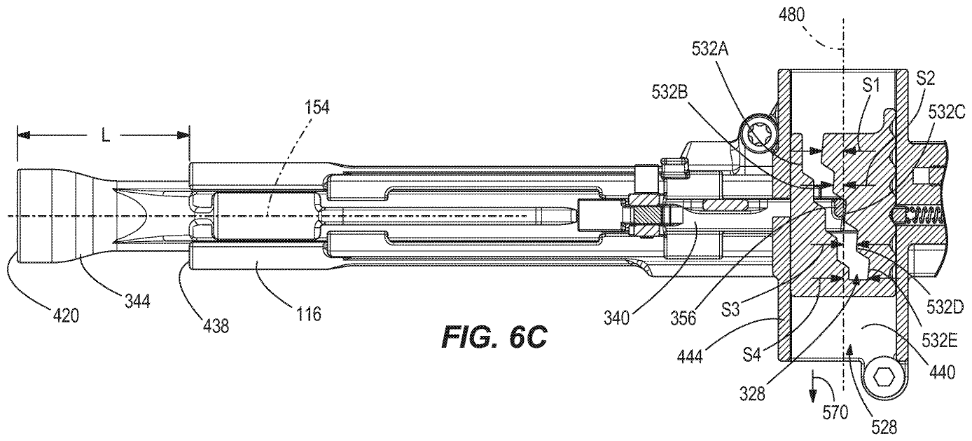

The fastener driver 100 can fire a nail into a workpiece to a certain depth as determined by a depth adjustment assembly 436 (FIGS. 5A and 5D). The desired depth is determined by an effective length L (FIG. 6C) of the workpiece contact assembly 328 (e.g., a length of the second end 420 of the lower workpiece contact member 344 relative to a distal end 438 of the nosepiece 116). The depth adjustment assembly 436 includes a shuttle 440 and a shuttle frame 444.

With respect to FIGS. 5B and 6A, the shuttle frame 444 forms part of the workpiece contact assembly 328. That is, the shuttle frame 444 forms part of the upper workpiece contact member 340 and thus moves with upper workpiece contact member 344 between the retracted position and the extended position. The shuttle frame 444 includes a first end 448 and a second end 452 opposite the first end 448. The first end 448 defines a spring perch 456. The detector 347 is also coupled to the shuttle frame 444 adjacent to the first end 448. The biasing member 346 extends between the shuttle frame 444 and the inner frame 186. The biasing member 346 biases the shuttle frame 444, with the upper workpiece contact member 340, toward the extended position. The shuttle frame 444 further includes a first wall 464 positioned between the first end 448 and the second end 452 and a second wall 468 positioned adjacent to the second end 452. The first wall 464 and the second wall 468 are spaced apart from one another by a base wall 472. The first wall 464, the second wall 468, and the base wall 472 define a slot 476. The slot 476 defines a shuttle axis 480 that is transverse to the driving axis 154. Each of the first and second walls 464, 468 includes a lip 484, 486 extending towards one another. A first opening 488 extends through the first wall 464 and receives a spring biased detent 492. The detent 492 extends into the slot 476. A second opening 496 extends through the second wall 468 and is configured to receive the first end 348 of the upper workpiece contact member 340, such that the first projection 356 is positioned within the slot 476. A rear surface 500 of the shuttle frame 444 includes a projection 504. The projection 504 is T-shaped and configured to be slidably received within the auxiliary channel 332 of the nosepiece. The projection 504 extends through the slot 336, such that the shuttle frame 444 is positioned forward of the nosepiece 116.

With respect to FIGS. 5B and 5D, the shuttle 440 is positioned within the slot 476 of the shuttle frame 444 and slidable along the shuttle axis 480. With respect to FIG. 6B, the shuttle 440 includes a first end 508 and second end 512 opposite the first end 508. The first end 508 defines a first wall 516 having a plurality of recesses 520 that extends along a width thereof, each configured to selectively receive the detent 492. The second end 512 includes a second wall 524. The second wall 524 is shorter than the first wall 516 in a direction measuring perpendicular to the driving axis. The shuttle 440 defines a channel 528 between the first and second ends 508, 512. The channel 528 opens toward the base wall 472 of the shuttle frame 444 and is configured to receive the first projection 356 of the upper workpiece contact member 340. The channel 528 has a plurality of steps 532. Each of the steps 532 corresponds to a desired depth to which a fastener will be driven. Each of the steps 532 in the channel 528 functions as a stop against which the first projection 356 of the upper workpiece contact member 340 may sit.

In the illustrated embodiment, there are five steps including a lowermost step 532A, intermediate steps 532B, 532C, 532D, and an uppermost step 532E. The lowermost step 532A is positioned at a first perpendicular distance S1 relative the shuttle axis 480 in a direction toward the distal end 438 of the nosepiece 116. A first intermediate step 532B is positioned at a second perpendicular distance S2 relative to the shuttle axis 480 in a direction toward the distal end 438 of the nosepiece 116. The first perpendicular distance S1 of the first intermediate step 532A is greater than the second perpendicular distance S2. A second intermediate step 532C is generally aligned with the shuttle axis 480. The third intermediate step 532D is positioned a third perpendicular distance S3 relative to the shuttle axis 480 in a direction away from distal end 438 of the nosepiece 116. The uppermost step 532E is positioned at a fourth perpendicular S4 distance relative the shuttle axis 480 in the direction away from the distal end 438 of the nosepiece 116. The third perpendicular distance S3 is smaller than the fourth perpendicular distance S4.

In the illustrated embodiment, the shuttle 440 includes a first portion 536 and a second portion 540, and the channel 528 extends between the first portion 536 and the second portion 540. The first portion 536 extends from the first wall 516 to the channel 528 and has a first thickness. The second portion 540 extends from the second wall 524 to the channel 528 and has a second thickness that is less than the first thickness 548. Accordingly, the first portion 536 has a rear surface 556 that is supported by the base wall 472 of the shuttle frame 444 and the second portion 540 is spaced apart from the base wall 472 of the shuttle frame 444. The lips 484, 486 of the first and second walls 464, 468 slidably engage a front surface 560 of the shuttle 440. A post 564 is disposed on the front surface 560 of the shuttle 440 and is configured to be coupled to an actuator 568 that is accessible from outside of the housing 112. The actuator 568 is configured to be actuated by the user to slide the shuttle frame 444 along the axis of the shuttle 440, transverse to the driving axis 154.

As noted above, the shuttle frame 444 is part of the workpiece contact assembly 328 and the shuttle 440 is supported by the shuttle frame 444. Therefore, the shuttle frame 444, the shuttle 440, and the workpiece contact assembly 328 move in unison between the extended position and the retracted position. With respect to FIG. 6C, to adjust the depth of drive, the user uses the actuator 568 to laterally move the shuttle 440 within the slot 476 along the shuttle axis 480 and transverse to the driving axis 154. As the shuttle 440 moves, the first projection 356 of the upper workpiece contact member 340 is adjusted relative to the plurality of steps 532. For example, moving the shuttle 440 in a first direction of arrow 570, moves the first projection 356 in a direction from the lowermost step 532A to the uppermost step 532E, which decreases the effective length L of the workpiece contact assembly 328 and increases the depth to which the fastener is driven into the workpiece. In another example, moving the shuttle 440 in a second direction opposite the arrow 570, moves the first projection 356 in a direction from the uppermost step 532E to the lowermost step 532A, which increases the effective length L of the workpiece contact assembly 328 and reduces the depth to which the fastener is driven into the workpiece. Moreover, moving the first projection 356 to one of the intermediate steps 532B, 532C, 532D in the first direction of the arrow 570 or in the second direction opposite the arrow 570 adjusts the effective length L of the workpiece contact assembly 328 in a similar way. The detent 492 is configured to engage one of the recesses 520 to retain the shuttle 440 in each position.

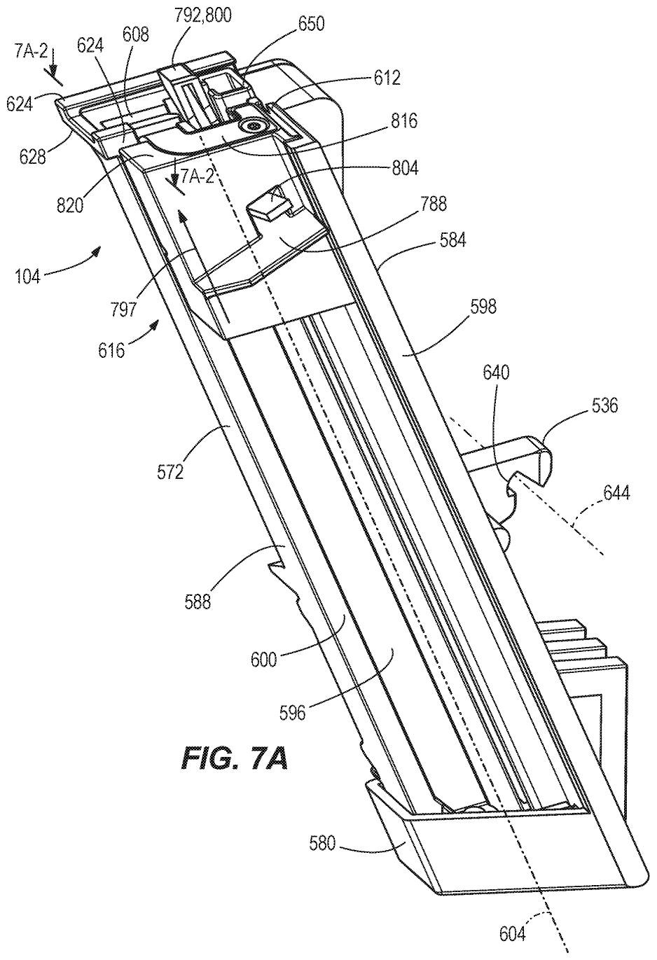

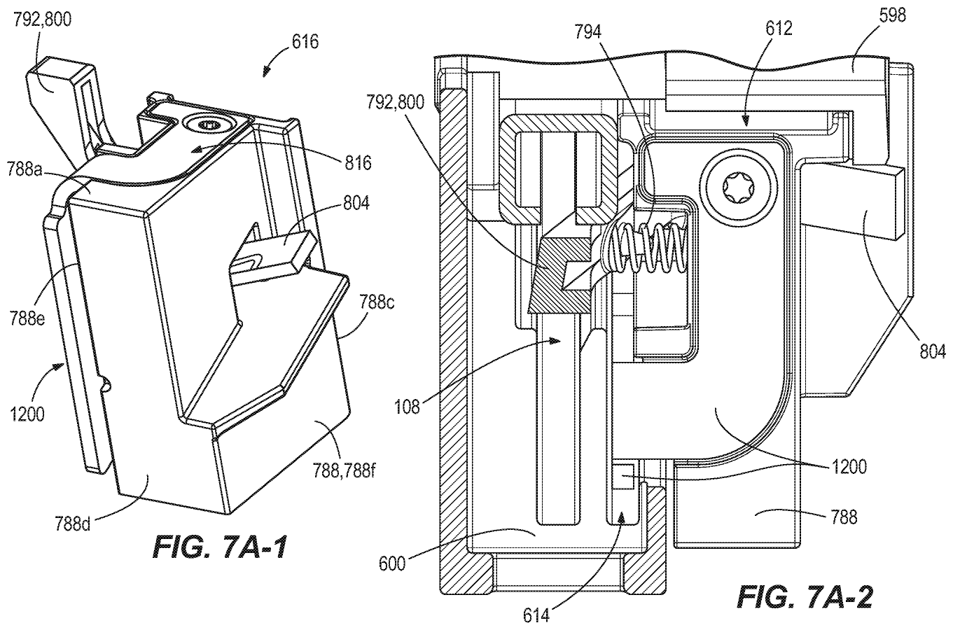

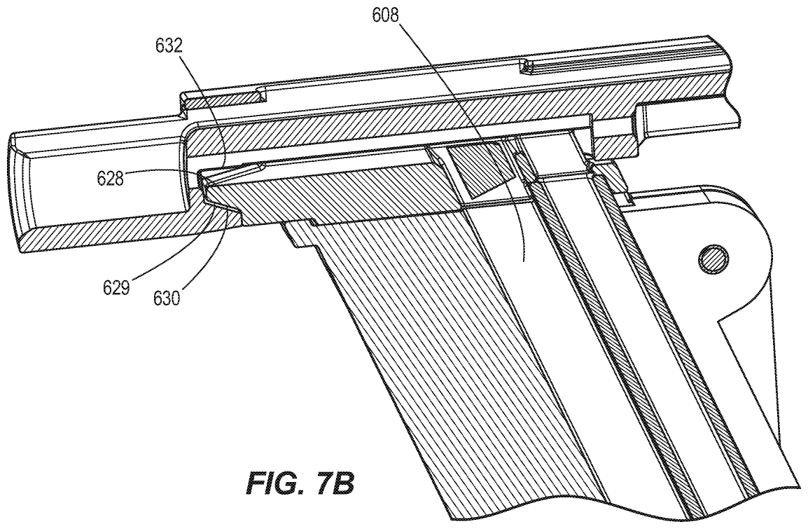

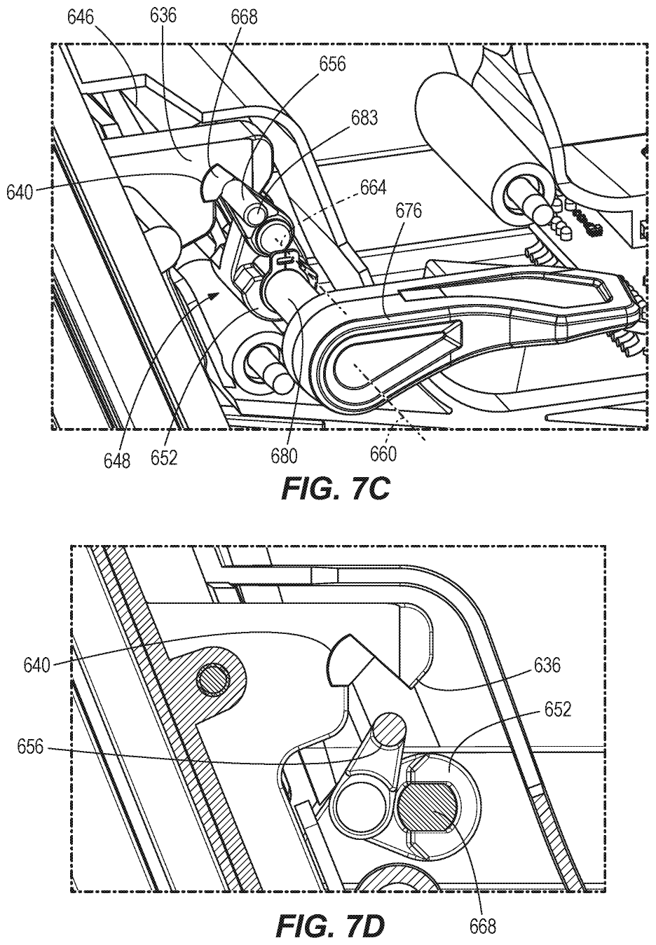

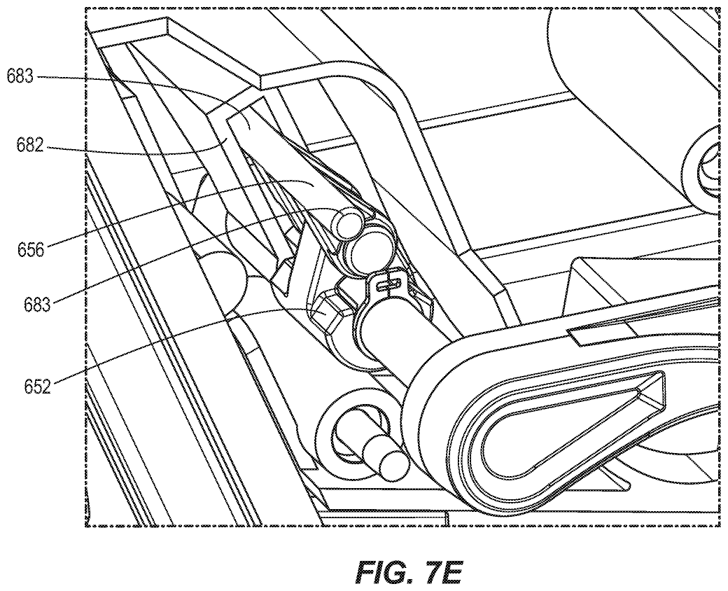

With reference to FIG. 1A-2, the magazine assembly 104 is removably coupled to the fastener driver 100. With respect to FIG. 7A, the magazine assembly 104 includes a magazine body 572 configured to receive the fasteners to be driven by the powered fastener driver 100. The magazine body 572 includes a front end 576 coupled to the nosepiece 116 and a rear end 580 opposite the front end 576. A top side 584 and a bottom side 588 extend between the front end 576 and rear end 580. The top side 584 is opposite the bottom side 588. A first side 592 (FIG. 1B) and a second side 596 extend between the front end 576 and the rear end 580. In the illustrated embodiment, the magazine body 572 comprises a first portion 598 and a second portion 600 coupled to the first portion 598. In other embodiments, the magazine body 572 may be integrally formed as a single portion. A longitudinal axis 604 (FIGS. 2 and 7A) extends between the front end 576 and the rear end 580. In the illustrated embodiment, the longitudinal axis 604 is positioned at an oblique angle relative to the driving axis 154. In other embodiments, the longitudinal axis 604 may be positioned a perpendicular angle.

With respect to FIG. 7A, the magazine body 572 defines a fastener channel 608 extending from the front end 576 to proximate the rear end 580. The fastener channel 608 is configured to receive the fasteners and align them consecutively along the longitudinal axis 604. Also, the magazine body 572 defines channels 612, 614 configured to support and guide a pusher assembly 616, discussed in greater detail below. In the illustrated embodiment, the first portion 598 and the second portion 600 cooperatively define the fastener channel 608 and the first channel 612. Also, a fastener guide 620 is positioned within magazine body 572 and is configured to receive the head of the fasteners. The second portion 600 defines the second channel 614. The channels 612, 614 are generally parallel to the longitudinal axis 604.

The front end 576 further includes feed lips 624 that are received within the nosepiece 116 to align the fastener channel 608 of the magazine body 572 with the fastener driving channel 108 of the nosepiece. A bottom projection 628 extends from the bottom side 588 and is positioned at the front end 576. The feed lips 624 at least partially define the bottom projection 628. With respect to FIG. 7B, the bottom projection 628 is configured to be removably received in a complementary groove 632 in the nosepiece 116. As shown, the bottom projection 628 is a tapered projection. That is the bottom projection 628 has a tapered or angled surface 629 that is configured to engage a tapered or angled surface 630 of the groove 632 of the nosepiece 116. The angled surface 629 of the bottom projection 628 is oblique to the longitudinal axis 604 of the magazine body 572. The angled surface 630 of the groove of the nosepiece 116 is oblique to the driving axis 154.

As shown in FIG. 7A, a top projection 636 extends from the top side 584 and is disposed between the front end 576 and the rear end 580. The top projection 636 defines a groove 640. The groove 640 defines an axis 644 that is generally transverse to the longitudinal axis 604 of the magazine assembly 104. The top projection 636 is configured to be removably received within an aperture 646 in the housing 112. In the illustrated embodiment, the top projection 636 is received within the aperture 646 (FIGS. 2, 7C) in the drive unit support portion 220.

With respect to FIG. 7C, an over-center latch 648 is coupled to the housing 112 of the fastener driver 100 and configured to removably couple the magazine assembly 104 to the housing 112. Specifically, the over-center latch 648 is configured to removably couple the top projection 636 of the magazine body 572 within the housing 112. The over-center latch 648 includes a first link 652 pivotally coupled to the housing 112, a second link 656 pivotably coupled to the first link 652, and an actuator assembly 672.

The actuator assembly 672 is coupled to the housing 1112 and is fixedly coupled to the first link 652. In particular, the actuator assembly 672 has an actuator 676 that is accessible from outside the housing 112 (e.g., the drive unit support portion 220 of the housing 112) and has a shaft 680 that extends from the actuator 676 into the housing 112. As shown in FIG. 7E, the shaft 680 is axially and vertically constrained by a pair of grooves 682 (only one of which is shown) in the housing 112. The first link 652 is fixedly coupled to the shaft 680. The actuator 676 is movable between a latched position and a released position.

With respect to FIGS. 7C and 7E, the first link 652 includes a first end and a second end opposite the first end. The first end is fixedly coupled to the shaft 680. The first link 652 is pivotable about a first link axis 660 defined by the shaft 680. The second link 656 includes a first end and a second end opposite the first end. The first end is pivotably coupled to the second end of the first link 652 and the second end has projections 683 that are slidable within the grooves 682 on opposite sides of the housing. The first end of the second link 656 is pivotable about a second link axis 664, which is parallel to the first link axis 660, and this causes sliding movement of the second end (and therefore the projections 683) of the second link 656 relative to the housing 112. Both the first and second link axes 660, 664 are generally transverse to the driving axis 154.

The second link 656 is pivotable relative to the first link 652 between an engaged position (FIG. 7C) and a disengaged position (FIG. 7D). In the engaged position, the second link 656 is at least partially positioned within the groove 640, and the magazine assembly 104 is locked in place. In the disengaged position, the second link 656 is removed (e.g., spaced apart) from the groove 640, permitting the magazine assembly 104 to be removed from the housing 112.

The actuator 676 is configured to move the second link 656 from the engaged position to the disengaged position. The actuator 676 is movable from the latched position to the released position in a first direction (e.g., counterclockwise from the perspective of FIG. 7C) to pivot the first link 652 in the first direction, which causes the second link 656 to pivot in a second direction (e.g., clockwise from the perspective of FIG. 7C). Accordingly, as the second link 656 pivots in the second direction, the second link 656 is moved from the engaged position to the disengaged position. The actuator 676 is movable from the released position to the latched position in the second direction to pivot the first link 652 in the second direction, which causes the first link 652 to pivot in the first direction. As the second link 656 pivots in the first direction, the second link 656 is moved from the disengaged position to the engaged position. A biasing member (e.g., a torsion spring, not shown) may maintain the actuator assembly 672 in the latched position to therefore maintain the second link 656 in the engaged position. In other embodiments, a cam engagement may maintain the actuator assembly 672 in the latched position instead. Additionally, a slug 668 (e.g., a compression slug) or other suitable element may be retained within the groove 640 to exert a force on the second link 656.

To remove the magazine assembly 104, the user moves the actuator 676 from the latched position to the released position to move the second link 656 into the disengaged position. With the second link 656 disengaged from the top projection 636, the user can move (e.g., pivot) the top side 584 of the magazine assembly 104 away from the housing 112 to remove the top projection 636 from the housing 112. This allows the bottom projection 628 to pivot within the groove 632 of the nosepiece 116 such that the front end 576 of the magazine assembly 104 can be released from the nosepiece 116. A pivot hinge is thus defined between the magazine assembly 104 (e.g., the feed lips 624) and the nosepiece 116. To install the magazine assembly 104, the user places the feed lips 624 against the nosepiece 116 so that the bottom projection 628 is received in the groove 632 in the nosepiece 116. The user moves (e.g., pivots) the magazine assembly 104 toward the housing 112, such that the magazine assembly 104 pivots relative to the nosepiece 116 (e.g., via the pivot hinge). As the top side 584 of the magazine body 572 moves toward the housing 112, the top projection 636 is inserted in the housing 112. With the top projection 636 received within the housing 112, the user can move the actuator 676 from the released position to the latched position to move the second link 656 to the engaged position and into the groove 640. The magazine assembly 104 is thus locked in place relative the housing 112.

The magazine assembly 104 shown herein may be interchangeable with an alternative magazine assembly having a different configuration. For example, the alternative magazine assembly may be configured to receive fasteners having a different configuration or have a different size that is able to accommodate more or fewer fasteners, etc. Moreover, the alternative magazine assembly may replace a broken magazine in another example.

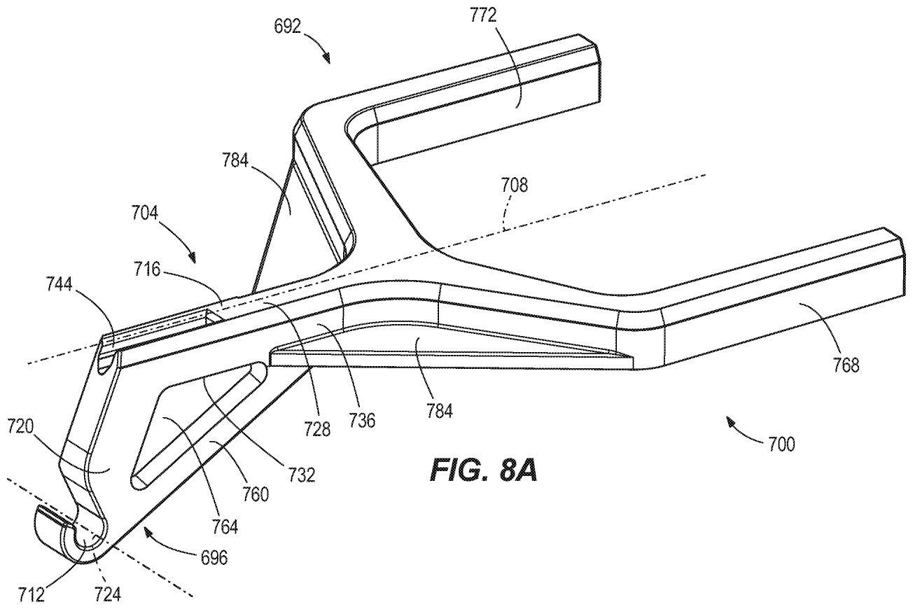

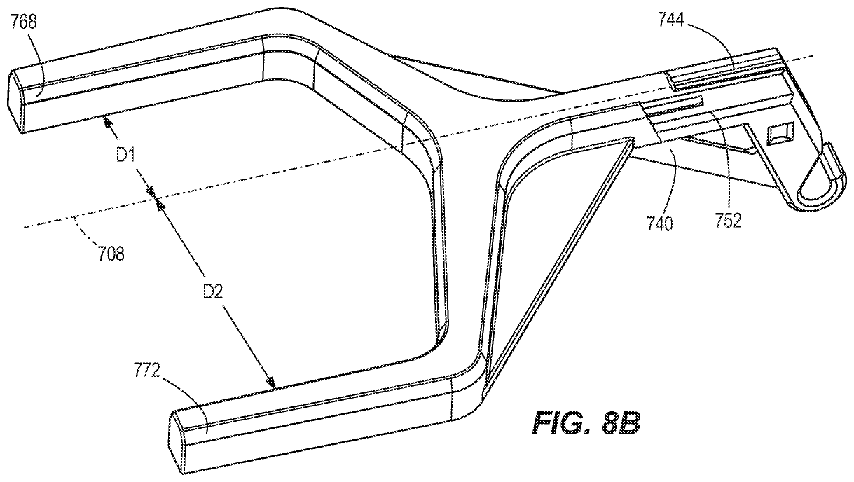

With reference to FIG. 1B, the magazine assembly 104 includes a kickstand 692 configured to hold the fastener driver 100 in an upright position (not shown) when supported on a horizontal surface. The kickstand 692 is movably coupled to the magazine assembly 104 between the front end 576 and rear end 580 of the magazine assembly 104. As shown in FIG. 8A, the kickstand 692 includes a mounting portion 696, a support portion 700, and an intermediate portion 704 disposed between the mounting portion 696 and the support portion 700. A longitudinal axis 708 extends between the mounting portion 696 and the support portion 700.

The mounting portion 696 includes an aperture 712 configured to receive a fastener 714 to pivotably couple the kickstand 692 to the magazine assembly 104. In the illustrated embodiment, the mounting portion 696 includes a front end 716 coupled to and extending from the intermediate portion 704 and a rear end 720 including a fish-hook shape. The aperture 712 extends through the rear end 720 of the mounting portion 696. An axis 724 of the aperture 712 is generally perpendicular to the longitudinal axis 708 of the kickstand 692. The aperture 712 is not fully closed due to the fish-hook shape.

With respect to FIGS. 8A and 8B, the intermediate portion 704 includes a front surface 728, a rear surface 732 opposite the front surface 728, a first side surface 736, and a second side surface 740 (FIG. 8B) opposite the first side surface 736. The front surface 728 has a channel 744. The channel 744 has a V-shaped cross section and extends along the longitudinal axis 708 of the kickstand 692. The channel 744 is configured to slidably engage with a first projection 748 (FIG. 8C) on the magazine assembly 104. In the illustrated embodiment, the first projection 748 of the magazine assembly 104 is on the first side 592 thereof. With reference to FIG. 8B, the second side surface 740 includes a slot 752 that receives a second projection 756 (FIG. 8C) of the magazine assembly 104, which is also on the first side 592 thereof. The slot 752 is generally parallel to the longitudinal axis of the kickstand 692. A support brace 760 extends from the rear end 720 of the mounting portion 696 to the rear surface 732 of the intermediate portion 704 creating a triangular shaped orifice 764.

The support portion is U-shaped and has a first foot 768 and a second foot 772 spaced apart from the first foot 768. The first foot 768 and the second foot 772 are parallel to each other, and parallel to the longitudinal axis 708 of the kickstand 692. The first foot 768 is disposed on a first side of longitudinal axis 708 at a distance D1 therefrom. The second foot 772 is disposed on a second side of the longitudinal axis 708 and at a distance D2 therefrom. The distance D1 is less than the distance D2. Moreover, as shown in FIG. 4A, the first foot 768 is positioned on the first side 592 of the magazine assembly 104 and the second foot 772 is positioned on the second side 596 of the magazine assembly 104 such that the first foot 768 and the second foot 772 straddle the driving axis 154. The first foot 768 and the second foot 772 are spaced apart from the driving axis 154 by about the same distance D3 (FIG. 4A). Flat support gussets 784 extend from the support portion 700 to the intermediate portion 704.

The kickstand 692 is pivotable about the fastener between a first position (FIG. 1B) and a second position (not shown). In the first position, the first foot 768 and the second foot 772 extend from the bottom side 588 of the magazine assembly 104. As shown, the longitudinal axis 708 of the kickstand 692 is generally parallel to the driving axis 154, as are the first foot 768 and the second foot 772. The first foot 768 and the second foot 772 extend beyond the workpiece contact assembly 328. Accordingly, the first foot 768 and the second foot 772, together with a surface of the battery pack 236, may support the fastener drive in the upright position. In the second position, the first foot 768 and the second foot 772 extend in the direction of the rear end 580 of the magazine assembly 104. The longitudinal axis 708 is generally oblique to the driving axis 154. Accordingly, the first foot 768 and the second foot 772 are stored and do not prevent the workpiece contact assembly 328 from engaging the workpiece.

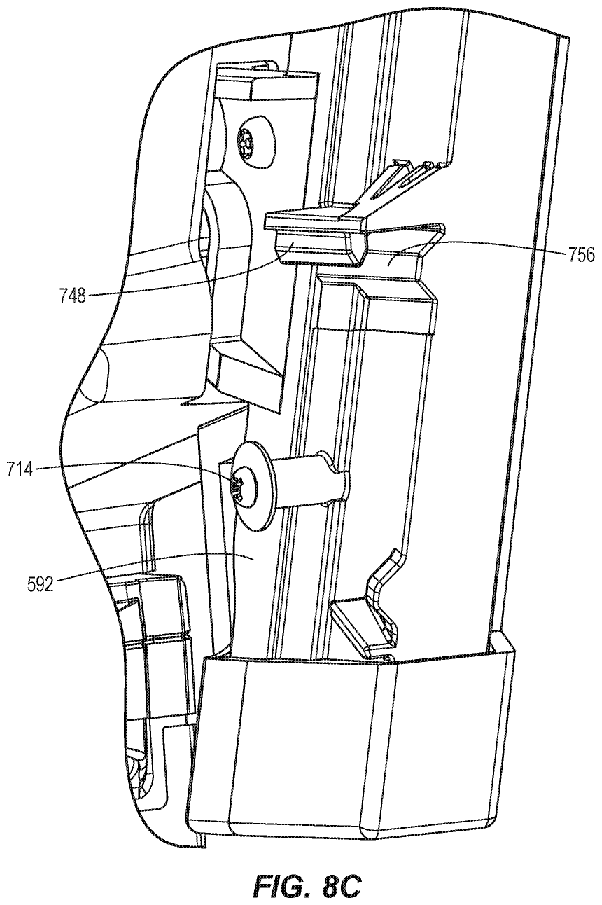

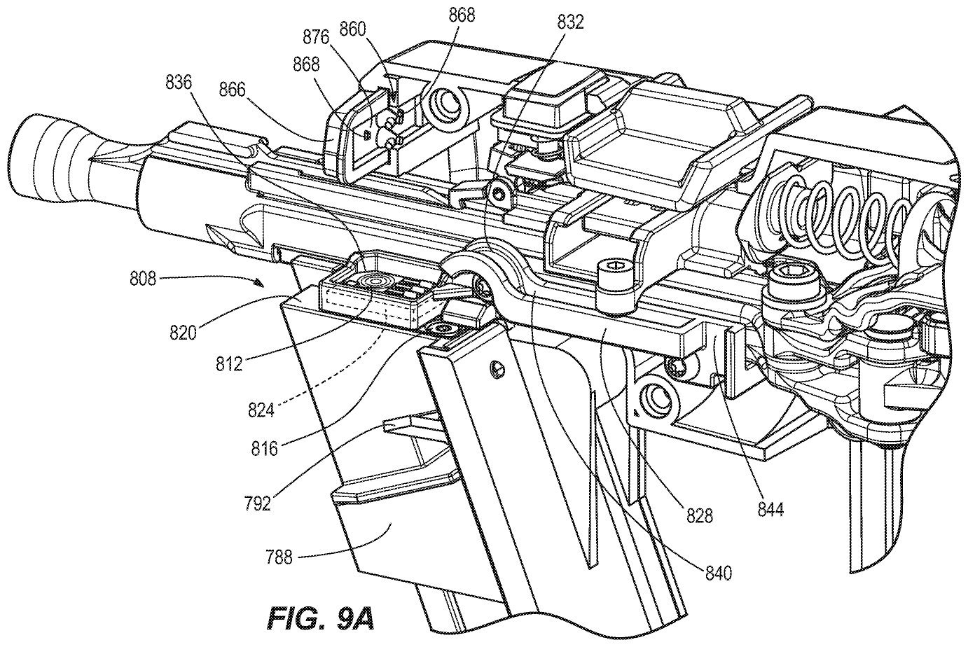

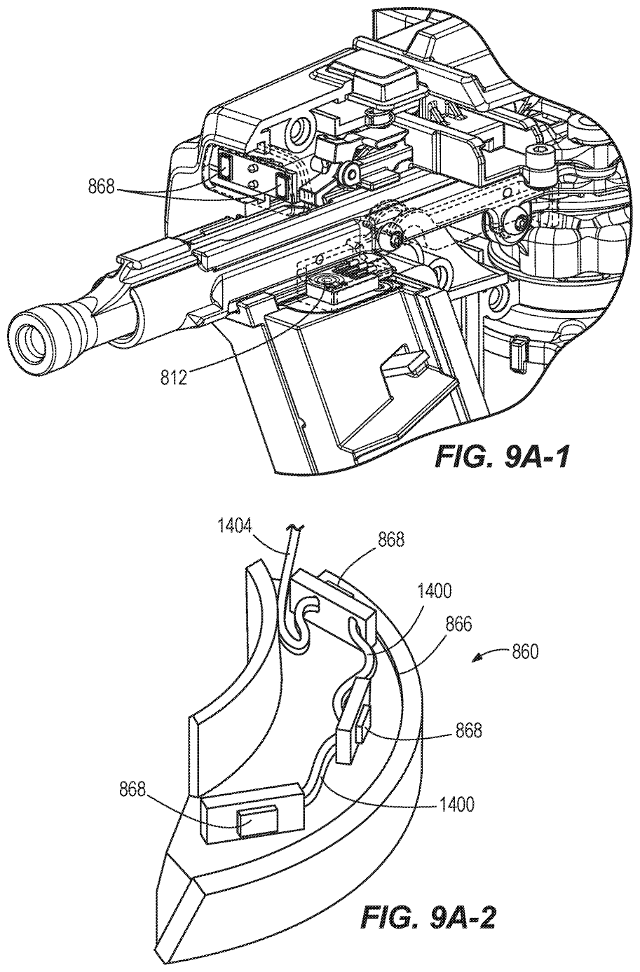

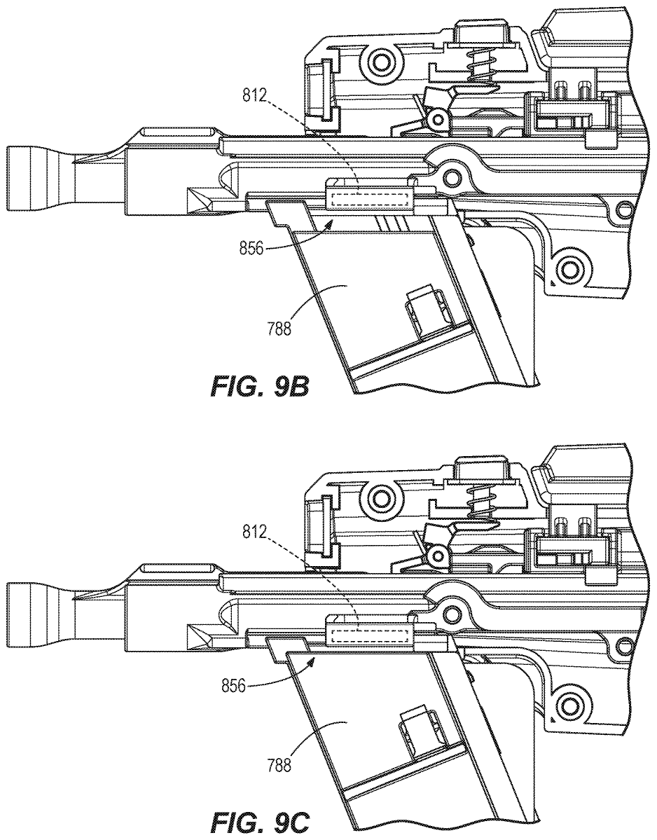

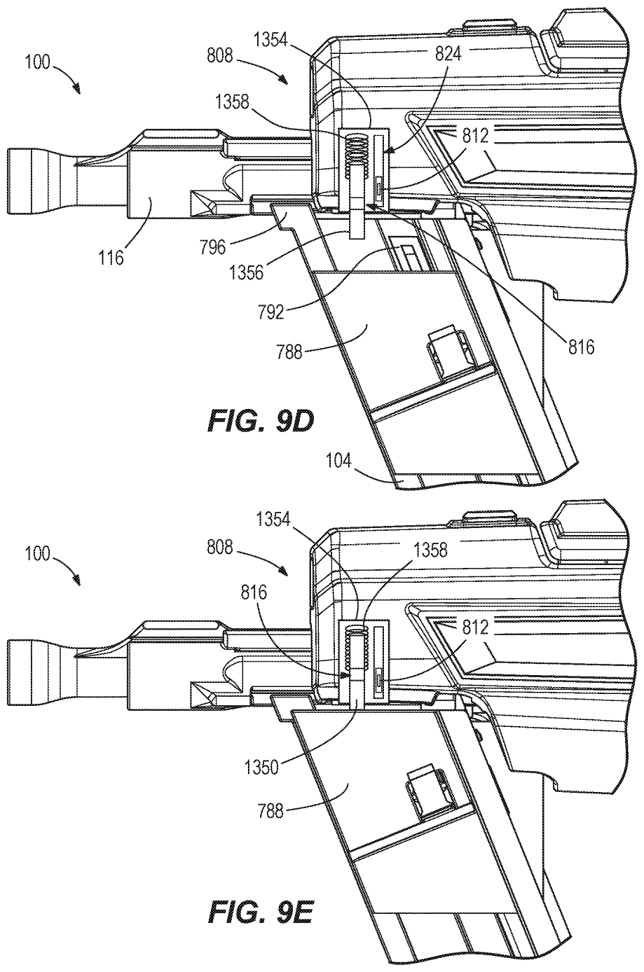

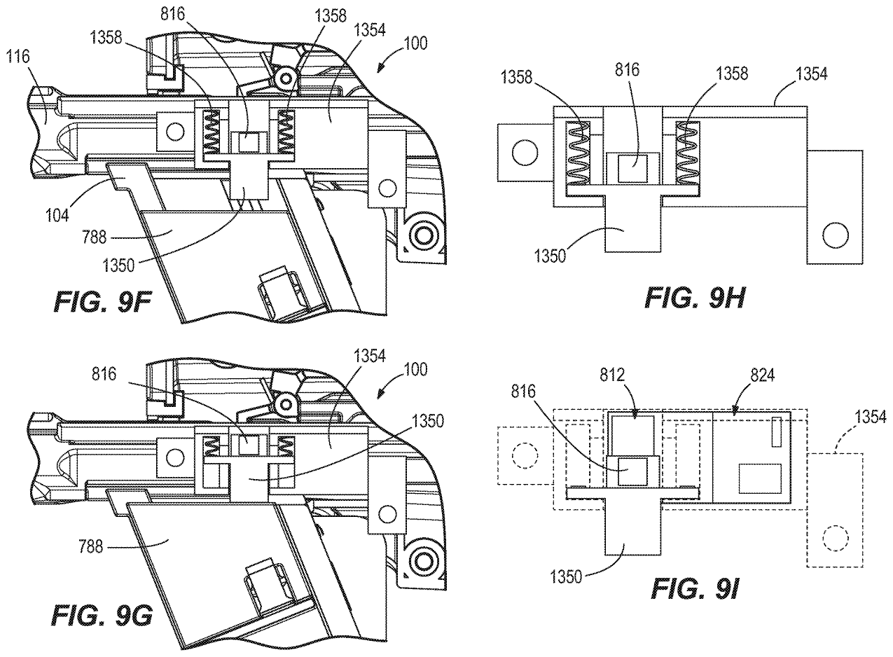

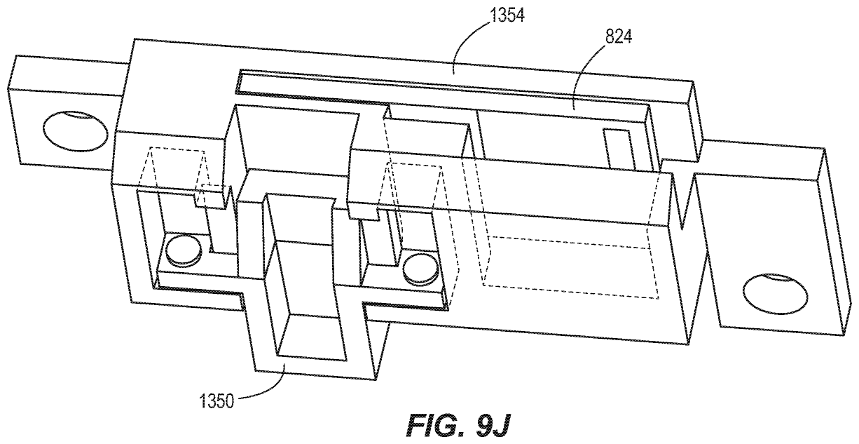

With renewed reference to FIGS. 7A and 9A, as noted above, the magazine assembly 104 further includes the pusher assembly 616 supported by the magazine assembly 104. The pusher assembly 616 is slidably coupled to the magazine assembly 104 and configured to bias the fasteners in the magazine assembly 104 toward the fastener driving channel 108. The pusher assembly 616 is movable from a first position in which a pusher body 788 is positioned at or adjacent to the rear end 580 to a second position (FIG. 7A) in which the pusher body 788 is positioned at or adjacent to the front end 576.

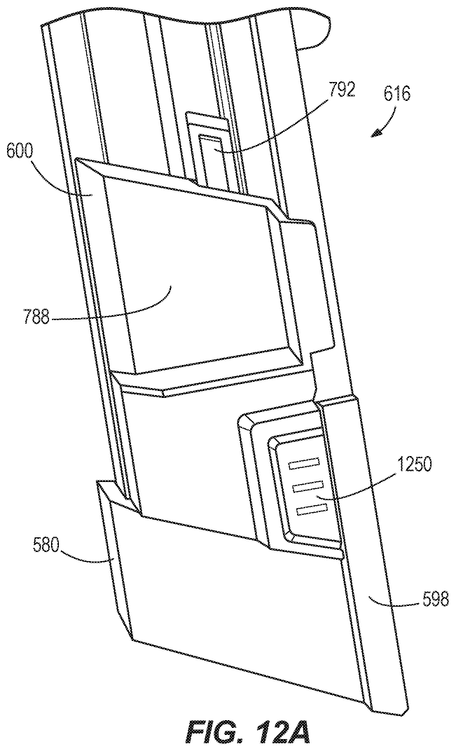

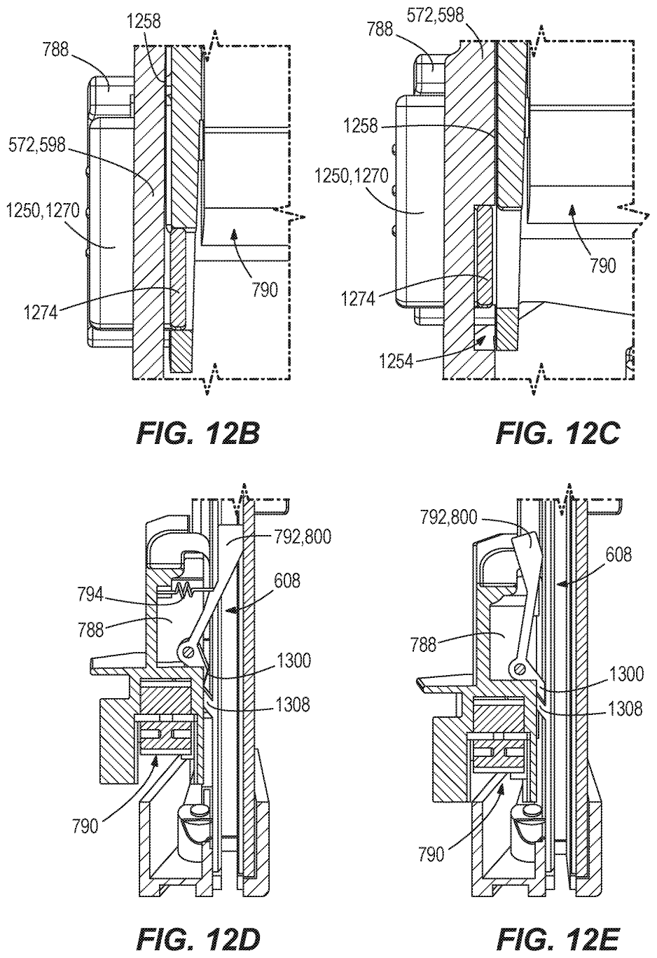

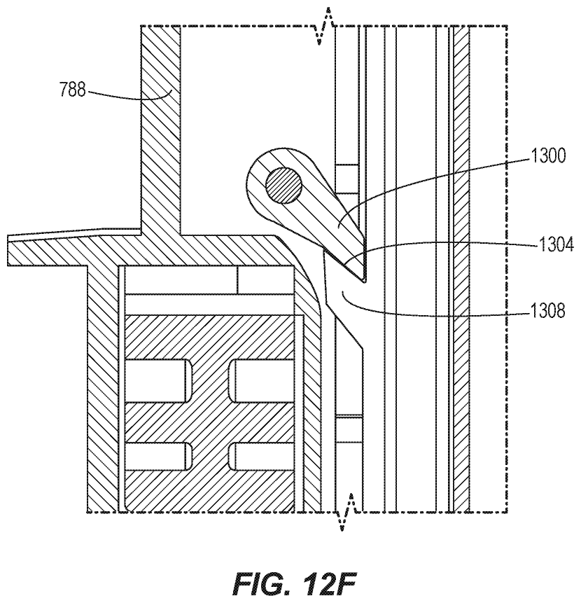

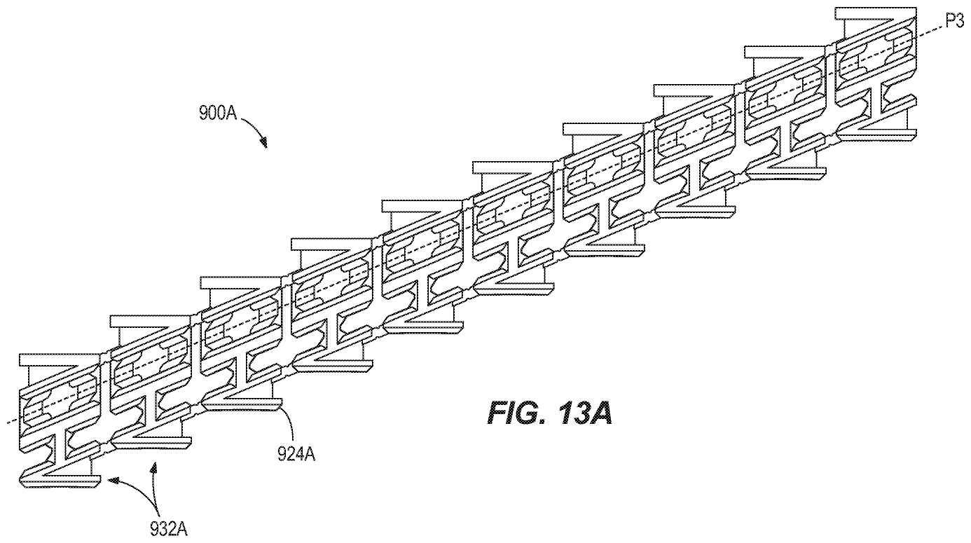

The illustrated pusher assembly 616 includes the pusher body 788 and a pusher finger 792 pivotably coupled to the pusher body 788. A first end of a spring assembly 790 (a portion of which is shown in FIGS. 12B-12E) is configured to exert a biasing force on the pusher assembly 616 for moving the pusher assembly 616 in the direction of arrow 797 (e.g., towards the nosepiece 116 and the fastener driving channel 108).

With further respect to FIGS. 7A to 7A-2, the pusher body 788 includes front end 788a, a rear end 788b opposite the front end 788a, a top side 788c, a bottom side 788d opposite the top side 788c, a first side 788e, and a second side 788f opposite the first side 788e. In the illustrated embodiment, a pusher guide 1200 is coupled to the pusher body 788. The pusher guide 1200 has front portion that is coupled to the front end 788a of the pusher body 788 and a side portion that is supported adjacent to the first side 788e of the pusher body 788. As shown, the pusher guide 1200 (e.g., the side portion thereof) extends from the bottom side 788d, as well. Accordingly, the side portion of the pusher guide 1200 creates a lip of the pusher body 788. In the illustrated embodiment, the pusher guide 1200 is formed from a metal material, but in other embodiments, the pusher guide 1200 may be formed from another suitable material. The pusher guide 1200 provides three functions. The front portion of the pusher guide 1200 provides a stop surface when the pusher body engages the nosepiece 116. The front portion of the pusher guide 1200 forms part of the dry fire lockout mechanism (which will be discussed in greater detail below). The side portion of the pusher guide 1200 is received within the magazine body 572 to assist in guiding the pusher body along the longitudinal axis 604.

With respect to FIGS. 7A and 9A, the pusher body 788 is supported by both the first and second portions 598, 600 of the magazine body 572. That is, the pusher body 788 (e.g., at least the top side 584 thereof) is at least partially positioned within the first channel 612 of the magazine body 572, while the pusher guide is at least partially positioned within second channel 614 of the second portion 600. The metal of the pusher guide 1200 helps the pusher body wear better over time. The pusher finger 792 is pivotably supported by the pusher body 788. The pusher finger 792 includes a first end 800 that is positioned on the first side 788e of the pusher body 788 and a second end 804 opposite the first end 800 that extends outwardly from the second side 788f of the pusher body 788. The pusher finger 792 is movable between an engaged position in which the first end 800 is positioned within the fastener channel and configured to engage the last fastener in the fastener channel 608 and a disengaged or bypass position in which the first end 800 is at least partially removed from fastener channel 608. A spring 794 biases the pusher finger 792 into the engaged position. A force exerted on the second end 804 of the pusher finger 792 temporarily moves the pusher finger 792 from the engaged position to the disengaged position such that the pusher assembly 616 is movable relative to the magazine body 572 from the second position back to the first position. When the force is removed from the second end 804 of the pusher finger 792, the bias of the spring returns the pusher finger 792 to the engaged position.

In some embodiments, such as that of FIGS. 12A-12F, the pusher assembly 616 may further include an actuator 1250 (e.g., button) configured to retain the pusher assembly 616 in the first position at the rear end 580 of the magazine assembly 104. As shown in FIGS. 12B and 12C, the magazine assembly 104 includes a recess 1254 at the rear end 580 thereof. Specifically, the recess 1254 is positioned a wall 1258 of the first channel 612 of the first portion 598 of the magazine body 572. As shown, the recess 1254 is thus in communication with the first channel 612. The actuator 1250 is movably supported by the pusher body 788.

The actuator 1250 includes a body 1270 and a tab 1274 extending from the body 1270. The actuator 1250 is movable between an unlocked position (FIG. 12B) and a locked position (FIG. 12C). In the unlocked position, the tab 1274 is positioned adjacent and movable (e.g., slidable) relative to the wall 1258 of the magazine body 572 (e.g., the wall 1258 of the first channel 612), such that the pusher body 788 is movable relative to the magazine body 572. In the locked position, the tab 1274 is positioned within the recess 1254 of the magazine body 572 (e.g., the wall 1258 of the first channel 612), such that the pusher body 788 is locked in the first position and nails can be inserted into the fastener channel 608. The actuator 1250 is biased into the locked position by a spring (not shown) positioned between the actuator 1250 and the pusher body 788. Thus, engagement of the tab 1274 with the magazine body 572 maintains the actuator 1250 in the unlocked position against the bias of spring. When the pusher body 788 reaches the first position and the tab 1274 is no longer engaged with the magazine body 572, the actuator 1250 automatically moves to the locked position due to the bias of the spring. When the actuator 1250 moves from the unlocked position to the locked position, it moves outwardly from the pusher body 788. After the user has loaded fasteners into the fastener channel 608, the user may exert a force inwardly toward the pusher body 788 to move the actuator 1250 from the locked position back to the unlocked position.

In the embodiment of FIGS. 12A-12F, the pusher finger 792 may automatically move to the bypass position when the pusher assembly 616 is locked in the first position by the actuator 1250. That is, the pusher finger 792 includes a cam 1300 that is configured to engage an angled surface 1304 of a projection 1308, which projects from the magazine body 572. As shown, the cam 1300 is positioned between the first end 800 and the second end 804 of the pusher finger 792. In the illustrated embodiment, the angled surface 1304 projects from the second side 596 of the magazine body 572, and in particular, the second portion 600 of the magazine body 572. As shown, the projection 1308 is between the front end 576 and the rear end 580 and is spaced apart from the rear end 580 of magazine body 572. Accordingly, the cam 1300 is offset from the recess 1254 in two directions (e.g., towards the front end 576 of the magazine body 572 and towards the bottom side 588 of the magazine body 572). When the cam 1300 engages the angled surface 1304, the pusher finger 792 is forced to pivot from the engaged position the bypass position so that fasteners can be loaded into the fastener channel 608. When the actuator 1250 is moved back to the unlocked position and the spring assembly 790 of the pusher assembly 616 biases same toward the front end 576 via the spring assembly 790, the cam 1300 disengages the angled surface such that the spring 794 forces the pusher finger 792 to pivot back to the engaged position to engage the fasteners.

With respect to FIG. 9A, the fastener driver 100 includes a dry fire lockout system 808 configured to prevent the fastener driver 100 from operating when the number of fasteners remaining in the magazine assembly 104 is less a predetermined number. The dry fire lockout system 808 includes a sensor 812 supported by the nosepiece 116 and a detector 816 coupled to the pusher body 788. In the illustrated embodiment, the detector 816 is a metal member. The detector 816 is coupled to a front surface 820 of the pusher body 788, as shown. In the illustrated embodiment, the detector 816 is part of the pusher guide 1200.

As shown in FIG. 9A, the sensor 812 is supported by a second printed circuit board 824, which is in electrical communication with the main electronic control unit 244 of the first printed circuit board 232. In the illustrated embodiment, the sensor 812 is an inductive sensor, but in other embodiments, the sensor 812 may be another type of sensor (e.g., a hall effect sensor). The second printed circuit board 824 is positioned within a guide member 828 that is coupled to the nosepiece 116. The guide member 828 includes a body 832 having a recess 836, a first slot 840, and a second slot 844 that intersects the first slot 840. The recess 836 receives the second printed circuit board 824. Wires extend from the second printed circuit board 824 and are guided to the first printed circuit board 232 via the first slot 840 and the second slot 844. That is, the wires extend in a direction toward a top side of the fastener driver 100 along the first slot 840 and then in a direction toward a rear end of the fastener driver 100 via the second slot 844. In the illustrated embodiment, the second slot 844 is positioned within the drive unit support portion 220 of the housing 112 such that the wires are guided through the drive unit support portion 220 to the first printed circuit board 232 in the connection portion of the housing 112.

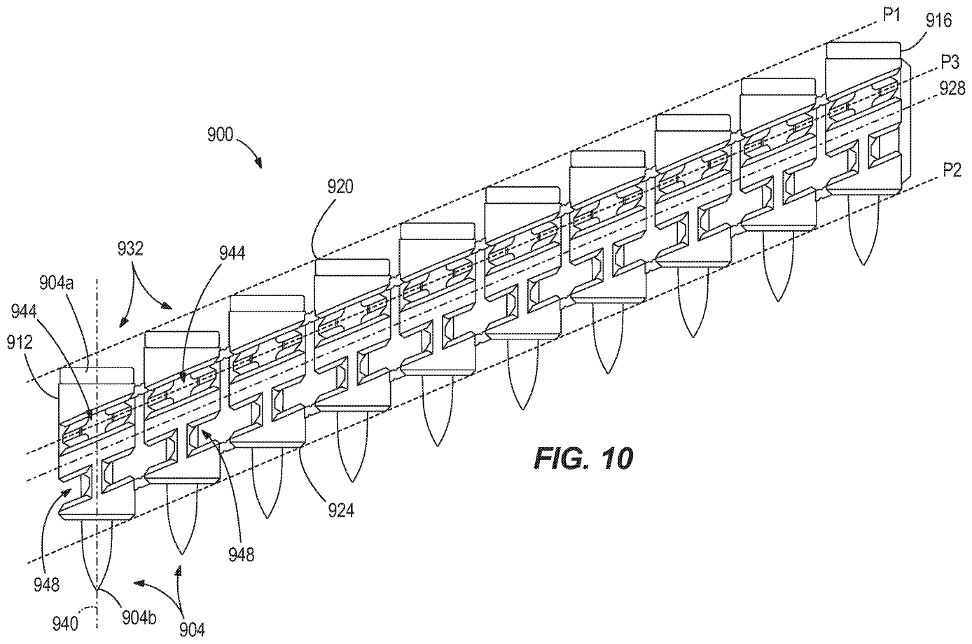

In operation, as shown in FIGS. 9B and 9C, the pusher assembly 616 (e.g., the pusher body 788) moves toward the front end 576 of the magazine assembly 104 as a user fires fasteners from the fastener driver 100 via the bias of the spring assembly. As shown in FIG. 9B, when there is more than a predetermined number of fasteners within the magazine assembly 104 (e.g., one or more fasteners), a gap 856 between the detector 816 and the inductive sensor 812 is greater than a predetermined distance and the sensor 812 will not be triggered. As shown in FIG. 9C, when there is the predetermined number of fasteners within the magazine assembly 104 (e.g., zero fasteners), a gap 856 between the detector 816 and the inductive sensor 812 is less than or equal to the predetermined distance and the inductive sensor 812 will be triggered. When triggered, the inductive sensor 812 sends an output control signal to the main electronic control unit 244 (via the wires) indicating that the predetermined number of fasteners is remaining. Therefore, the inductive sensor 812 is operable to detect the last or one of the last of the predetermined number of fasteners remaining in the magazine assembly 104. In response to the output control signal of the sensor 812, the main electronic control unit 244 disables the powered fastener driver 100 until the magazine assembly 104 is reloaded with fasteners, such that the gap 856 between the detector 816 and the inductive sensor 812 is once again greater than the predetermined distance. For example, the main electronic control unit 244 will not activate the motor 166 to start when the output control signal is received from the inductive sensor 812. In the illustrated embodiment, a collation 900 (shown in FIG. 10, for example) may control the distance between the detector 816 and the inductive sensor 812.

In other embodiments, the detector 816 may be positioned on a spring-biased plunger 1350, rather than on the pusher body 788 itself. In the embodiments of FIGS. 9D-9J, the second printed circuit board 824, including the sensor 812 (e.g., the inductive sensor), and the spring-biased plunger 1350 are supported by a sensor housing 1354. Although not shown, the sensor housing 1354 may be incorporated into the guide member 828, discussed above, or separately coupled to the nosepiece 116.

In the embodiment of FIGS. 9E to 9J, the plunger 1350 includes a front end that contacts the sensor housing 1354 and a rear end that is opposite the front end. The detector 816 (e.g., metal member) is supported by the plunger 1350. At least one spring 1358 is supported by the sensor housing 1354 and engages the plunger 1350. The plunger 1350 is movable between a first or disengaged position (FIG. 9D and FIG. 9F) and a second or engaged position (FIGS. 9E and 9G).

In the disengaged position, the rear end of the plunger 1350 projects from the sensor housing 1354 and the detector 816 is spaced apart from and unaligned with the sensor 812. The spring(s) 1358 bias the plunger 1350 into the disengaged position. Because the detector 816 is spaced apart from the sensor 812 in the disengaged position, the sensor 812 will not be triggered, as discussed above.

In the engaged position, the rear end of the plunger 1350 is positioned with sensor housing 1354 or projects from the sensor housing 1354 by a smaller distance than in the disengaged position, and the detector 816 is at least partially aligned with the sensor 812. The plunger 1350 is moved against the bias of the spring(s) 1358 from the disengaged position to the engaged position by the pusher body 788 as the pusher body 788 moves towards the nosepiece 116. Because the detector 816 is at least partially aligned with the sensor 812 in the engaged position, the sensor 812 will be triggered, as discussed above. Therefore, the inductive sensor 812 is operable to detect the last or one of the last of the predetermined number of fasteners remaining in the magazine assembly 104.

The plunger 1350 and springs 1358 may be various configurations. In the embodiment of FIGS. 9D-9E, the detector 816 is positioned between the front end and the rear end thereof. Moreover, in the embodiment of FIGS. 9D-9E, a single spring 1358 engages the plunger 1350 and biases the plunger 1350 into the disengaged position. As shown, the single spring 1358 is generally aligned along an axis of the plunger 1350 extending between the front and rear end. The axis along which the spring-biased plunger 1350, including the detector 816, is movable is parallel to a plane defined by the inductive sensor 812.

In the embodiment of FIGS. 9F-9J, the detector 816 is positioned at or adjacent to the front end of the plunger 1350. In the embodiment of FIGS. 9G-9J, a pair of springs 1358 engage the front end of the plunger 1350. As shown, one of the pair of springs 1358 is positioned on one side of the detector 816 and one of the pair springs 1358 is positioned on an opposite side of the detector 816. The axis along which the spring-biased plunger 1350, including the detector 816, is movable is parallel to a plane defined by the inductive sensor 812.

With renewed reference to FIG. 9A to 9A-2, the powered fastener driver 100 also includes a light assembly 860 disposed on the housing 112 above the fastener driving channel 108. As shown, the light assembly 860 is positioned at a bottom side 864 of the tool adjacent to the workpiece contact assembly 328. As shown, the light assembly 860 is positioned adjacent to and forward of the fastener driving channel 108. The light assembly 860 includes a transparent housing 866 that is coupled to the housing 112. The light assembly 860 also includes at least two light emitting diodes (LEDs) 868. As shown in FIG. 9A, two LEDs 868 are mounted on a third printed circuit board 876. The LEDs 868 and the third printed circuit board 876 are supported by and positioned within the transparent housing 866. The third printed circuit board 876 is in electrical communication with the second printed circuit board 824 via one or more wires (not shown in FIG. 9A). The wires extending between the second printed circuit board 824 and the first printed circuit board 232 thus also electrically couple the LEDs 868 of the light assembly 860 to the main electronic control unit 244. In other embodiments, one or more wires may extend from the third printed circuit board 876 to the first printed circuit board 232. Accordingly, the LEDs 868 are configured to receive electrical power from battery pack 236 via the second printed circuit board 824.

In the embodiment of FIG. 9A-2, three LEDs 868 are supported by a transparent housing 866 coupled to the housing 112. The LEDs 868 are electrically coupled to one another via a plurality of wires 1400. The LEDs 868 are in electrical communication with the second printed circuit board 824 via a wire 1404 connected to one of the LEDs 868. The wires, discussed above, extending between the second printed circuit board 824 and the first printed circuit board 232 thus also electrically couple the LEDs 868 of the light assembly 860 to the main electronic control unit 244. In other embodiments, the wire 1404 may extend from one of the LEDs 868 to the first printed circuit board 232. Accordingly, the LEDs 868 are configured to receive electrical power from battery pack 236 via the second printed circuit board 824.

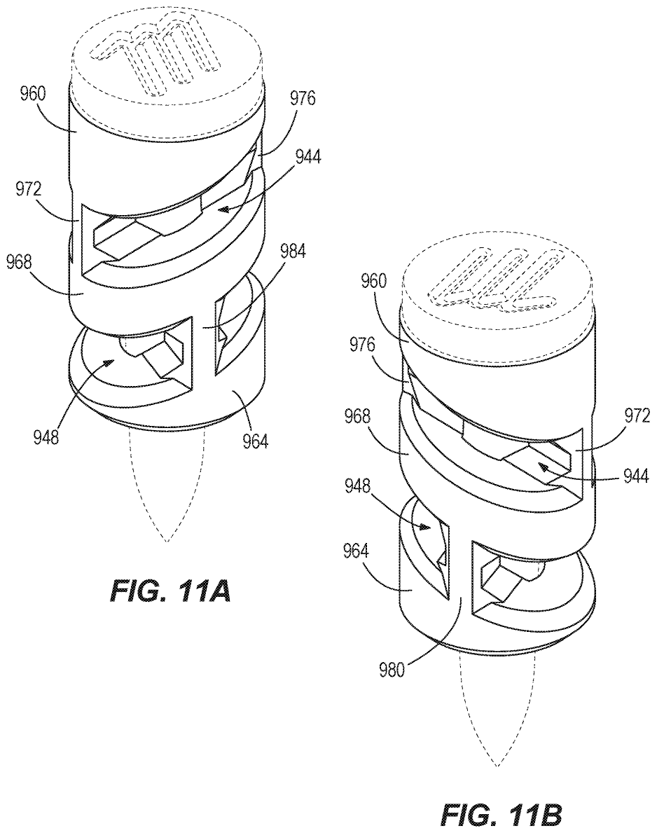

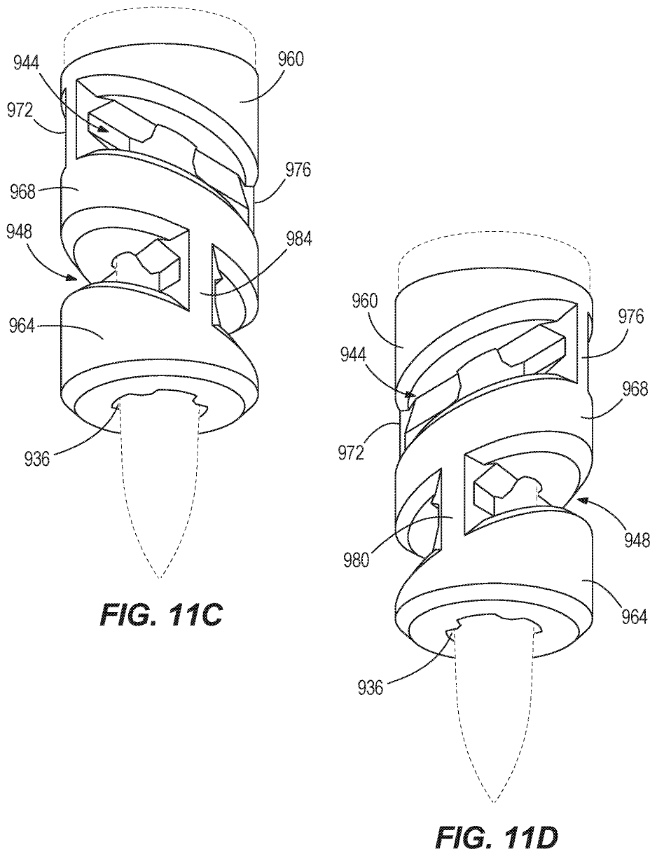

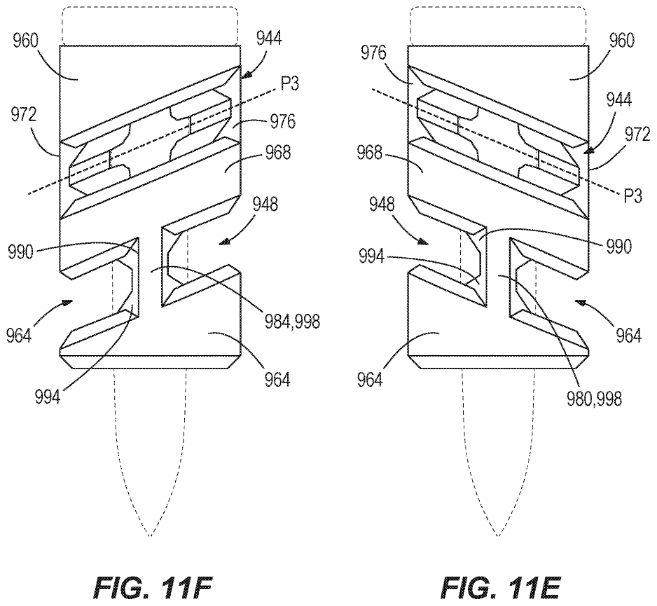

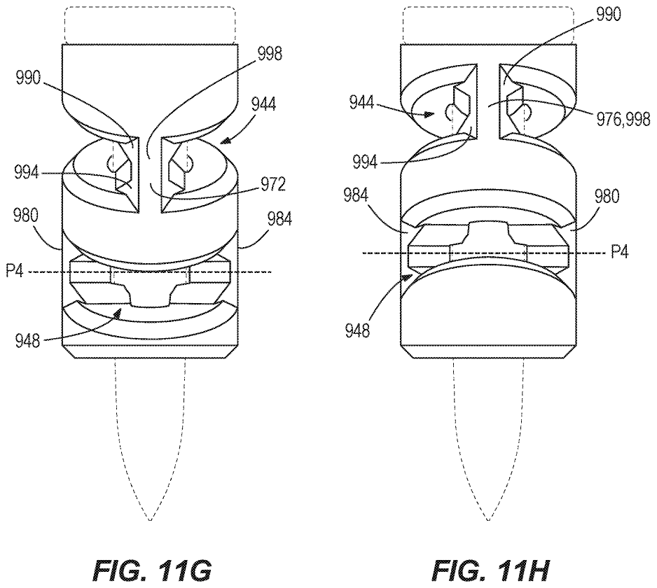

With respect to FIGS. 10-11H, a collation 900 for the fasteners 904 used with the powered fastener driver 100 is shown. With respect to FIG. 10, the collation 900 is configured to be received within the fastener channel 608 of the magazine assembly 104. As shown, the body of the collation 900 defines a front end 912, a rear end 916 opposite the front end 912, a top side 920, and a bottom side 924 opposite the top side 920. The top side 920 of the collation 900 defines a first plane P1 that is generally parallel to the top side 584 of the magazine body 572 and the bottom side 924 of the collation 900 defines a second plane P2 that is generally parallel to the bottom side 924 of the magazine body 572. A longitudinal axis 928 extends between the front end 912 and the rear end 916 and is configured to be aligned with the longitudinal axis 604 of the magazine body 572.

The collation 900 includes a plurality of receptacles 932 that are coupled to one another and consecutively between the front end 912 and the rear end 916 of the collation 900. The receptacles 932 are the same, and thus the following discussion of single receptacle 932 applies equally to each of the receptacles 932. The receptacle 932 has an aperture 936 configured to receive one of the fasteners 904. As shown, the aperture 936 extends along an axis 940 that extends between the top side 920 and the bottom side 924 of the collation 900. Moreover, a head 904a of the fastener 904 abuts or is otherwise positioned adjacent to the top side 920 of the receptacle 932 and the tip 904b of the fastener 904 projects from the bottom side of the receptacle 932. Additionally, the receptacle 932 includes a first crush zone 944 (e.g., an upper crush zone) and a second crush zone 948 (e.g., a lower crush zone). The upper crush zone 944 is positioned adjacent to the top side 920 of the collation 900, while the lower crush zone 948 is positioned adjacent to the bottom side 924 of the collation 900.

In the illustrated embodiment, the receptacle 932 includes an upper portion 960 positioned adjacent the top side 920, a lower portion 964 positioned adjacent the bottom side 924, and an intermediate portion 968 positioned between the upper portion 960 and the lower portion 964. The upper portion 960 is thus configured to be positioned adjacent to the head 904a of the fastener 904, while the lower portion 964 is configured to be positioned adjacent to the tip 904b of the fastener 904. The upper portion 960 is coupled to the intermediate portion 968 by a first beam 972 and a second beam 976. The first beam 972 and the second beam 976 on opposite sides of the aperture 936. The first beam 972 is on the front-end side of the receptacle 932 and the second beam 976 is on the rear-end side of the receptacle 932. The first beam 972 and the second beam 976 define the upper crush zone 944 between the upper portion 960 and the intermediate portion 968. Similarly, the lower portion 964 is coupled to the intermediate portion 968 by a third beam 980 and a fourth beam 984. The third beam 980 and the fourth beam 984 are on opposite sides of the aperture 936. The third beam 980 is on the first side of the receptacle 932 and the fourth beam 984 is on the second side of the receptacle 932. The third beam 980 and the fourth beam 984 define the lower crush zone 948 between the upper portion 960 and the intermediate portion 968.

Each of the beams 972, 976, 980, 984 is similar to an I-beam. The beams 972, 976, 980, 984 all have the same construction. Thus, while only the first beam 972 is described, the discussion applies equally to all the beams 972, 976, 980, 984. The first beam 972 includes a first flange 990 and a second flange 994. A web 998 extends between the first flange 990 and the second flange 994. The first flange 990 and the second flange 994 have generally triangular shape and therefore include angled or tapered surfaces. The web 998 defines generally planar surfaces on opposite sides thereof. Accordingly, a thickness of the beam 972 narrows in a direction from either the first flange 990 or the second flange 994 towards the web 998. In other words, a thickness of the web 998 is less than a thickness of the flanges 990, 994.

The first flange 990 of the first and second beams 972, 976 is coupled to (integrally formed with) the upper portion 960, while the second flange 994 is coupled to (integrally formed with) the intermediate portion 968. A third plane P3 is defined by the first and second beams 972 and 976. The third plane P3 bisects the webs 998 of both the first and second beams 972, 976 and is oriented parallel to the planar surfaces of the webs 998 of the first and second beams 972, 976. The third plane P3 is thus also parallel to the longitudinal axis 928 and transverse to the axis 940 of the aperture 936.

The first flange 990 of the third and fourth beams 980, 984 is coupled to (integrally formed with) the intermediate portion 968, while the second flange 994 is coupled to (integrally formed with) the lower portion 964. A fourth plane P4 is defined by the third and fourth beams 980, 984. The fourth plane P4 bisects the webs 998 of both the third and fourth beams 980, 984 and is parallel to the planar surfaces of the webs 998. The fourth plane P4 is thus also transverse to the longitudinal axis 928 and transverse to the axis 940 of the aperture 936. In the illustrated embodiment, the third plane P3 of the first and second beams 972, 976 (e.g., the upper crush zone 944) is also transverse to the fourth plane P4 of the third and fourth beams 980, 984 (e.g., the lower crush zone 948). In the illustrated embodiment, the third plane P3 of the first and second beams 972, 976 (e.g., the upper crush zone 944) is positioned at a 90-degree angle relative to the fourth plane P4 of the third and fourth beams 980, 984 (e.g., the lower crush zone 948). The relative positioning of the crush zones 944, 948 of each of the receptacles 932 promotes constant and even crushing of the receptacle 932 when the fastener 904 is driven into the workpiece.

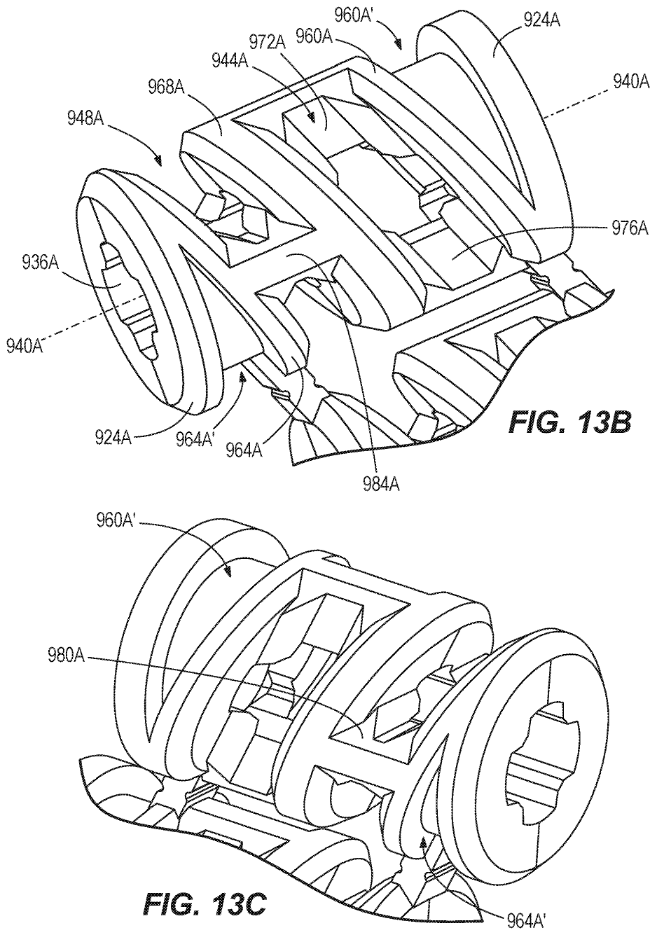

The receptacles 932 of FIGS. 10-11H are generally cylindrical along the axis 940. As shown, the top side 920 defines a circular perimeter and the bottom side 924 defines a circular perimeter. The top and bottom sides 920, 924 are the same size (e.g., they have the same diameter). The receptacles 932 may have other shapes, as shown and described relative to the embodiments of FIGS. 13A-17C.

That is, the collations 900A-D, and the corresponding receptacles 932A-D, of FIGS. 13A-16C are similar to the collation 900, and its receptacles 932, of FIGS. 10-11H. Therefore, like reference numerals will be identified with like structure plus the corresponding letter A-D, and only the differences will be discussed.

The receptacles 932A of FIGS. 13A-C are generally cylindrical along the axis 940A. As shown, the top side 920A defines a circular perimeter and the bottom side 924A defines a circular perimeter. The top and bottom sides 920A, 924A are the same size (e.g., they have the same diameter). The upper portion 960A of has a first recess 960A′ and the lower portion 964A has a second recess 964A′. As shown, the upper and lower recesses 960A′, 964A′ extend at least partially about the circumference of the respective portion 960A, 964A. Moreover, due to the structure and location of the crush zones 944A, 948A, each of the upper and lower portions 960A, 964A and the corresponding recesses 960A′, 964A′ have a dimension (e.g., length measured parallel to the axis 940A) that is variable about the circumference. The upper and lower recesses 960A′, 964A′ reduce the weight of the receptacle 932A. Additionally, the upper and lower recesses 960A′, 964A′ make the receptacle 932A easier to deform/crush during firing.

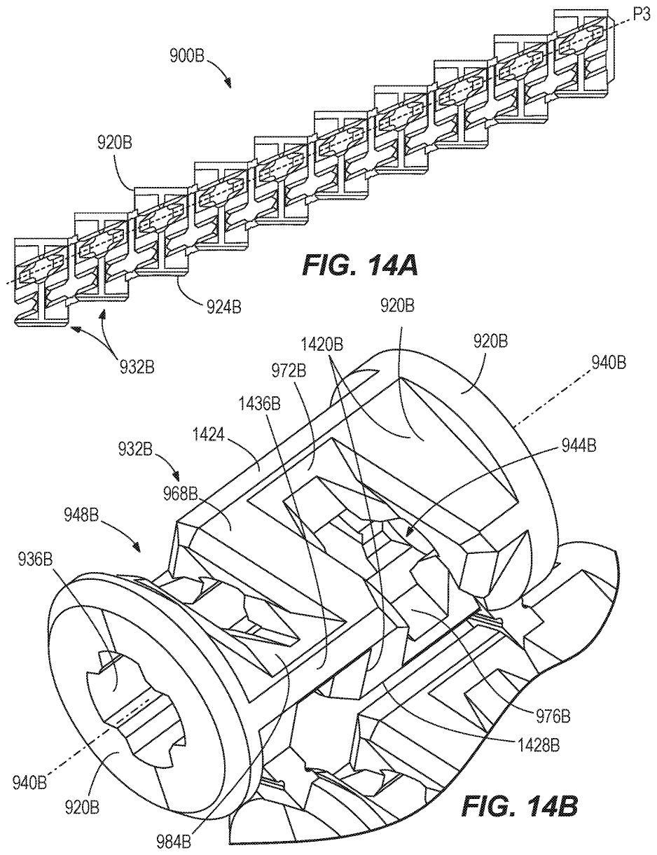

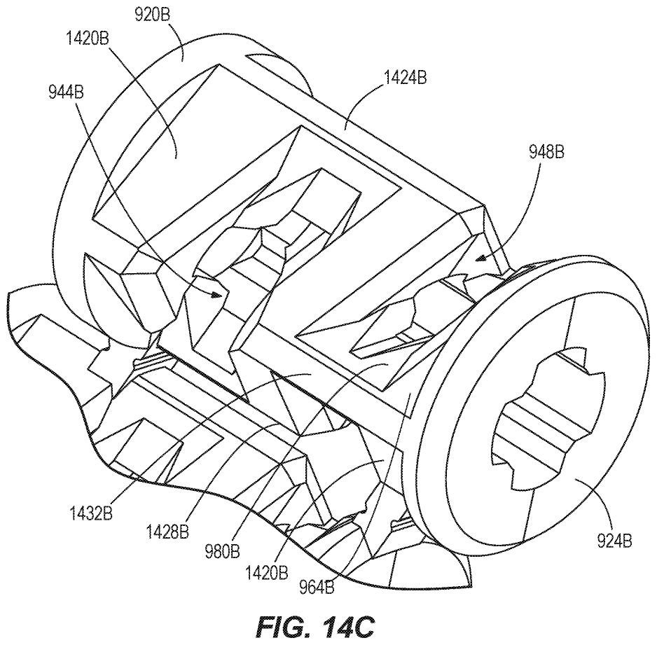

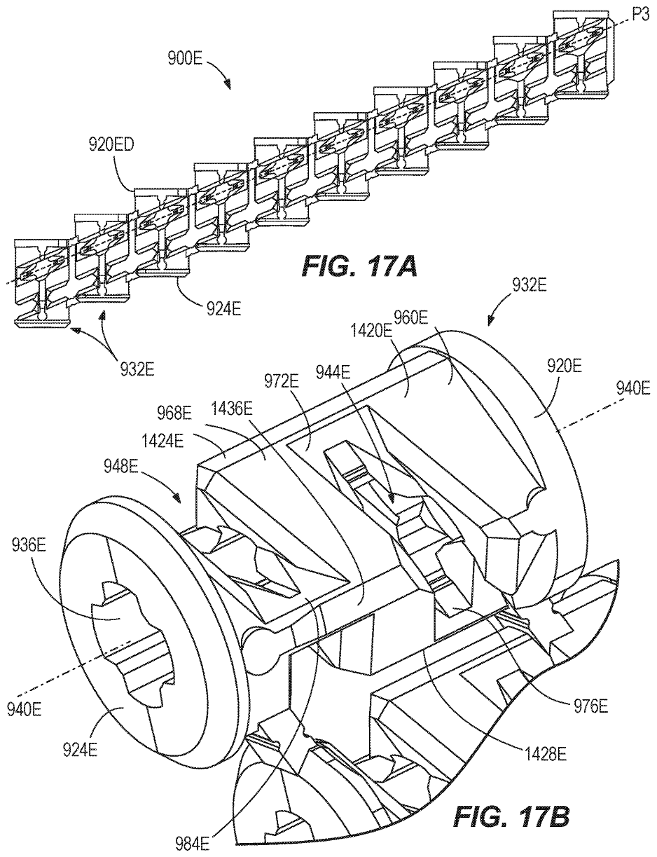

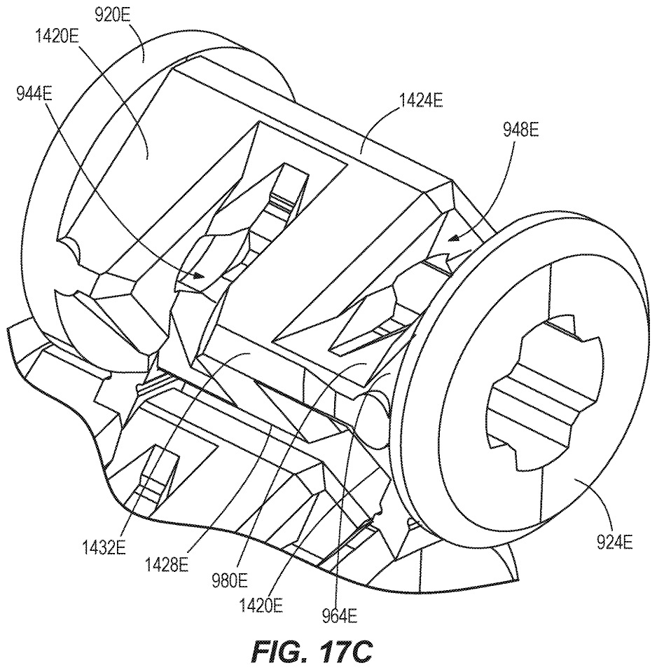

The receptacles 932B of FIGS. 14A-C include a top side 920B having a circular perimeter and a bottom side 924B having a circular perimeter. The first and second sides 920B, 924B are the same size (e.g., they have the same diameter). The upper portion 960B, the lower portion 964B, and the intermediate portion 968B collectively define a generally cuboidal portion 965 between the circular top and bottom sides 920B, 924B. Thus, the upper portion 960B, the lower portion 964B, and the intermediate portion 968B define a square perimeter. To achieve the structure of the receptacles 932B, material is removed from each of four sides each of the receptacle 932B between the top side 920B and the bottom side 924B, thus creating planar surfaces 1420B on the four sides. The planar surfaces 1420B collectively make up the square perimeter. As shown, the vertices 1424B, 1428B, 1432B, 1436B of the square perimeter (formed by the planar surfaces 1420B) are positioned on the front side, the rear side, the first side, and the second side, respectively. The vertices 1424B, 1428B on the front and rear sides are bisected by the third plane P3, while the vertices 1432B, 1436B on the first and second sides are bisected by the fourth plane P4. A maximum dimension between the vertices 1424B, 1428B on the front and rear sides is the same as the maximum dimension between the vertices 1432B, 1436B on the first and second sides. The maximum dimensions are substantially the same as the diameter of the top and bottom sides 920B, 924B. Including the planar surfaces 1420B reduces the weight of the receptacle 932B. Additionally, including the planar surfaces 1420B make the receptacle 932B easier to deform/crush during firing. The receptacles 932E of FIGS. 17A-17C have substantially the same features as the receptacles of 932B, as shown

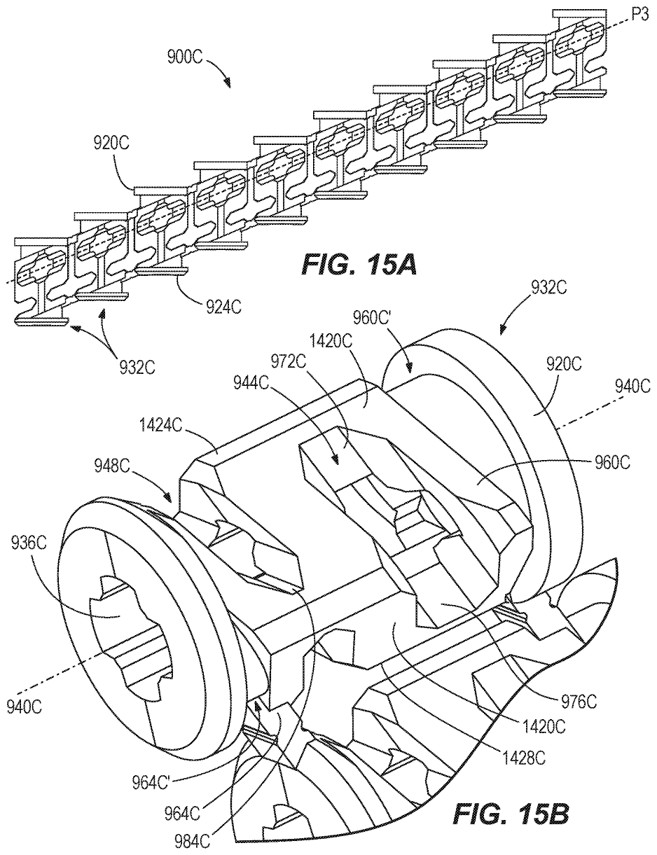

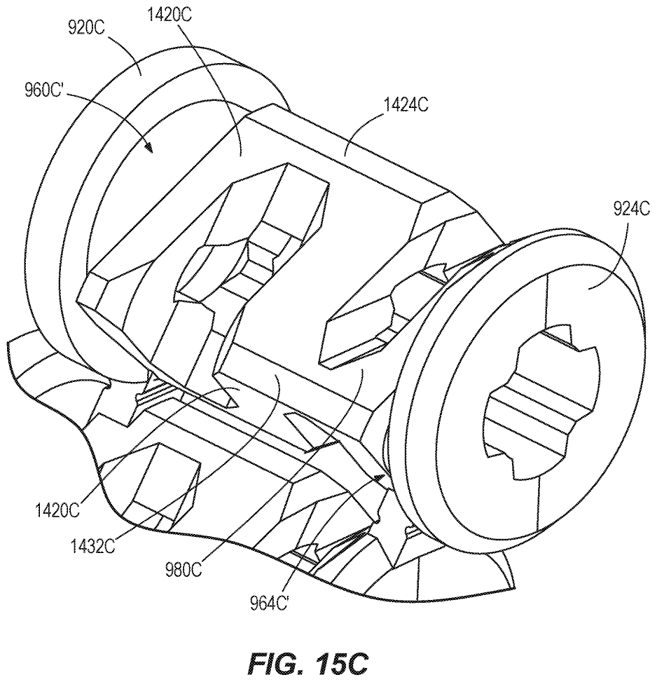

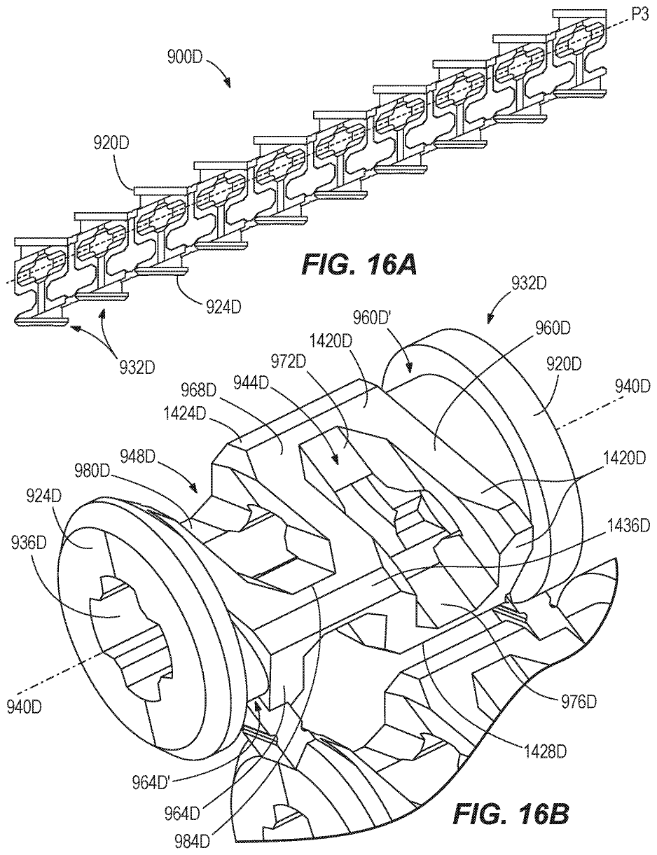

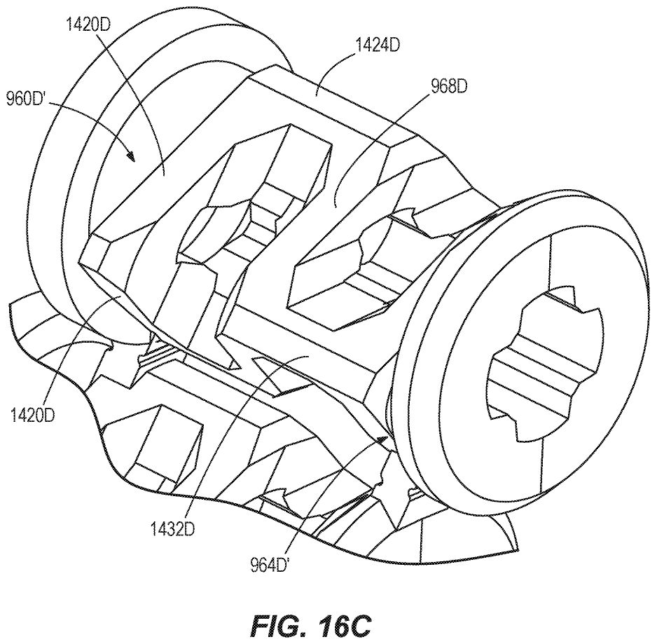

The receptacles 932C, 932D of FIGS. 15A-C and FIGS. 16A-16C, respectively, include the aspects of receptacles 932A of FIGS. 13A-13C and the receptacles 932B of FIGS. 14A-14C. Thus, like structure is noted with like reference numerals plus the letters “C” and “D”. Briefly, that is, the upper portion 960C, 960D, the lower portion 964C, 964D, and the intermediate portion 968A, 968B collectively define a cuboidal portion between circular top and bottom sides 920C, 924C, 920D, 924D. Also, the upper and lower portions 960C, 964C, 960D, 964D have first and second recesses 960C′, 964C′, 960D′, 964D′. The intermediate portion 968D has a length measured parallel to the axis 940D that is smaller than the lengths of the intermediate portions 968, 968A, 968B, 968C of the other receptacle embodiments. In the embodiment of the FIGS. 16A-16C, the intermediate portion 968D makes up less than 10% of the length of the receptacle 932D. In other embodiments, the intermediate portion 968D may make up 5% to 15% of the length of the receptacle 932D.

Although the disclosure has been described in detail with reference to certain preferred embodiments, variations and modifications exist within the scope and spirit of one or more independent aspects of the disclosure as described.

1. A powered fastener driver comprising:
a housing;
a nosepiece coupled to the housing and at least partially defining a fastener driving channel;
a light assembly positioned within the housing forward of the nosepiece, the light assembly including a light emitting diode;
an electronic control unit positioned within the housing and being in electrical communication with the light assembly to power the light emitting diode of the light assembly.

2. The powered fastener driver of claim 1, wherein the light assembly includes a light housing coupled to the housing of the powered fastener driver and a printed circuit board supported by the light housing, the light emitting diode positioned on the printed circuit board and configured to emit light through the light housing.

3. The powered fastener driver of claim 2, wherein the light assembly is in electrical communication with the electronic control unit via a wire extending from the printed circuit board.

4. The powered fastener driver of claim 3, further comprising a guide coupled to a side of the nosepiece, the guide configured to support the wire.

5. The powered fastener driver of claim 4, wherein the guide includes a first slot that guides the wire from a bottom end of the housing towards a top end of the housing and a second slot that guides the wire towards a rear end of the housing to the electronic control unit.

6. The powered fastener driver of claim 1, further comprising
a cylinder within the housing;
a piston movable within the cylinder from a top-dead-center (TDC) position to a driven or bottom-dead-center (BDC) position;
a driver blade attached to the piston for movement therewith along a driving axis from the TDC position toward the BDC position for driving a fastener into a workpiece through the fastener driving channel;
a lifter operable to move the piston and a driver blade, in unison, from the BDC position toward the TDC position; and
a motor supported within the housing and operably coupled to the lifter.

7. The powered fastener driver of claim 6, wherein the housing includes a cylinder support portion in which the cylinder is at least partially positioned, a drive unit support portion in which the motor is at least partially positioned, a handle portion, and a battery support portion in which the electronic control unit is at least partially positioned.

8. A powered fastener driver comprising:
a housing;
a nosepiece coupled to the housing and at least partially defining a fastener driving channel;
a light assembly positioned within the housing at a bottom end thereof and forward of the nosepiece, the light assembly including a light emitting diode; and
an electronic control unit positioned within the housing and being in electrical communication with the light assembly to power the light emitting diode of the light assembly.

9. The powered fastener driver of claim 8, wherein the light assembly includes a light housing coupled to the housing of the powered fastener driver and a printed circuit board supported by the light housing, the light emitting diode positioned on the printed circuit board and configured to emit light through the light housing.

10. The powered fastener driver of claim 9, wherein the light assembly is in electrical communication with the electronic control unit via a wire extending from the printed circuit board.

11. The powered fastener driver of claim 10, further comprising a guide coupled to a side of the nosepiece, the guide configured to support the wire.

12. The powered fastener driver of claim 11, wherein the guide includes a first slot that guides the wire from the bottom end of the housing towards a top end of the housing and a second slot that guides the wire towards a rear end of the housing to the electronic control unit.

13. The powered fastener driver of claim 8, further comprising
a cylinder within the housing;
a piston movable within the cylinder from a top-dead-center (TDC) position to a driven or bottom-dead-center (BDC) position;
a driver blade attached to the piston for movement therewith along a driving axis from the TDC position toward the BDC position for driving a fastener into a workpiece through the fastener driving channel;
a lifter operable to move the piston and driver blade, in unison, from the BDC position toward the TDC position; and
a motor supported within the housing and operably coupled to the lifter.

14. The powered fastener driver of claim 13, wherein the housing includes a cylinder support portion in which the cylinder is at least partially positioned, a drive unit support portion in which the motor is at least partially positioned, a handle portion, and a battery support portion in which the electronic control unit is at least partially positioned.

15. A powered fastener driver comprising:
a housing;
a nosepiece coupled to the housing and at least partially defining a fastener driving channel;
a light assembly positioned within the housing forward of the nosepiece, the light assembly including a light emitting diode and a wire in electrical communication with the light emitting diode;
an electronic control unit positioned within the housing and being in electrical communication with the light assembly via the wire to power the light emitting diode of the light assembly; and
a guide coupled to a side of the nosepiece, the guide configured to support the wire between the light emitting diode and the electronic control unit.

16. The powered fastener driver of claim 15, wherein the light assembly includes a light housing coupled to the housing of the powered fastener driver, and wherein the light emitting diode supported within the light housing and configured to emit light through the light housing.

17. The powered fastener driver of claim 15, further comprising
a cylinder within the housing;
a piston movable within the cylinder from a top-dead-center (TDC) position to a driven or bottom-dead-center (BDC) position;
a driver blade attached to the piston for movement therewith along a driving axis from the TDC position toward the BDC position for driving a fastener into a workpiece through the fastener driving channel;
a lifter operable to move the piston and a driver blade, in unison, from the BDC position toward the TDC position; and
a motor supported within the housing and operably coupled to the lifter.

18. The powered fastener driver of claim 17, wherein the housing includes a cylinder support portion in which the cylinder is at least partially positioned, a drive unit support portion in which the motor is at least partially positioned, a handle portion, and a battery support portion in which the electronic control unit is at least partially positioned.

19. The powered fastener driver of claim 18, wherein the guide includes a first slot that guides the wire from a bottom end of the housing towards a top end of the housing and a second slot that guides the wire towards a rear end of the housing to the electronic control unit.

20. The powered fastener driver of claim 19, wherein the second slot is positioned with the drive unit support portion.

21.-68. (canceled)
